(19) United States
(12) Patent Application Publication
(10) Pub. No.: US 2013/0166346 A1
(43) Pub. Date: Jun. 27, 2013

(54) Systems, Computer-Implemented Methods and Computer-Readable Media to Provide Multi-Criteria Decision-Making Model for Outsourcing

(71) Applicants: Dhia Al-Zuhair, Doha (SA); Nazih Aboul-Hassan, Dhahran (SA)

(72) Inventors: Dhia Al-Zuhair, Doha (SA); Nazih Aboul-Hassan, Dhahran (SA)

(73) Assignee: Saudi Arabian Oil Company, Dhahran (SA)

(21) Appl. No.: 13/722,731

(22) Filed: Dec. 20, 2012

Related U.S. Application Data
(60) Provisional application No. 61/579,510, filed on Dec. 22, 2011.

(51) Int. Cl. G06Q 10/06

(52) U.S. Cl. CPC G06Q 10/0635; G06Q 10/0637
USPC 705/7.28

(57) ABSTRACT

Embodiments including systems, computer-implemented methods, and computer-readable media can generate an outsourcing questionnaire interface to be displayed at a display. The outsourcing questionnaire interface can include a plurality of questions, relating to a plurality of outsourcing dimensions, and a corresponding plurality of response fields for users to respond with respect to a business process. Embodiments can further determine a plurality of dimensional scores for the business process responsive to a plurality of user-selected responses received at the plurality of response fields. Embodiments can further generate an outsourcing recommendation interface, to be displayed at the display, that is a graphical chart including a process-recommendation bubble, for the business process, which can be displayed having a position and size in the graphical chart determined responsive to one or more of the plurality of dimensional scores.

### CROSS-REFERENCE TO RELATED APPLICATIONS

The present application claims the benefit of U.S. Provisional Patent Application 61/579,510, filed Dec. 22, 2011.

### TECHNICAL FIELD

The present invention relates generally to the field of business-process outsourcing, in more particular aspects, the present invention relates to collecting information relating to business-process outsourcing from users and presenting graphical outsourcing recommendations to users.

### BACKGROUND

In terms of a business organization or other enterprise, “outsourcing” a business process of the business organization refers to migration of an “in-house” business process to be performed by an external service provider. In certain aspects, outsourcing may help a business organization improve on core competencies, improve quality, and reduce costs in other areas. In certain aspects, outsourcing may also relate to the relocation of business process to service providers in a different nation, which is sometimes referred to as “offshoring.” The term outsourcing may also refer to practices commonly referred to by other terms including “nearshoring,” “multisourcing,” “crowdsourcing,” and “strategic outsourcing.” One commonly-outsourced class of business processes includes business processes relating to information-technology (IT) services.

Considering whether to outsource a business process presents various complex and interrelated considerations. Without a proper evaluation of such complex and interrelated considerations, there are risks that business organizations may retain business processes that are better outsourced, fail to prepare business processes for outsourcing over time, or undertake disadvantageous outsourcing endeavors. Disadvantageously, outsourcing decisions may involve an informal or ad-hoc decision-making process and may be made by different departments in isolation and based on different (or, perhaps, conflicting) needs. Disadvantageous outsourcing endeavors may be undertaken, perhaps, where there is a lack of an objective framework to identify and prioritize outsourcing initiatives.

### SUMMARY OF THE INVENTION

Embodiments can provide systems, computer-implemented methods, computer-readable media, and graphical user interfaces to advantageously allow users to identify, analyze, prioritize, and plan for outsourcing opportunities for one or more business processes. In certain embodiments, for example, users can identify, analyze, prioritize, plan for outsourcing opportunities for business processes in the area of IT services. Embodiments employ a multiple-criteria decision/evaluation model that gives the users a structured and systematic approach for evaluating and selecting business processes for potential outsourcing. Embodiments described herein advantageously allow users (e.g., business-process owners) undertake a more complete and longer-term strategic solution for evaluating and identifying business processes for outsourcing.

Applicants have recognized the foregoing problems and limitations in the field and provide various embodiments to evaluate outsourcing opportunities across different businesses (e.g., different departments, different organizations, etc.) using a standardized analytic framework providing a “common yardstick” and to identify business processes as candidates for outsourcing.

In further detail, embodiments can apply an analytic framework based on various user-inputs received from one or more graphical user interfaces (“user inputs”). Applicants advantageously provide techniques for evaluating business processes as candidates for outsourcing that focus on relevant drivers for outsourcing and reduce subjectivity for the human inputs to such evaluation. In certain aspects, a business process can be identified as a candidate for outsourcing based on multi-dimensional ratings of the business process and a multi-dimensional graphical “outsourcing recommendation” that can be generated and presented to a user responsive to the multi-dimensional ratings. In certain embodiments, graphical outsourcing recommendations can not only identify a state of outsourcing-readiness, but can also identify the need for intermediate-stage service improvements and risk mitigation for business process not ready for outsourcing. The standardized analytic framework beneficially provides an objective, uniform, and repeatable model for strategic evaluation of the suitability for outsourcing business processes. In certain aspects, the analytic framework allows business-process owners to prioritize and select business processes for outsourcing as well as to prepare business process for future outsourcing potential. Also, applicants advantageously provide techniques that are modular and scalable, allowing different strategic profiles to be applied in the analytic framework or allowing customization of business-specific aspects of the analytic framework, for example, for different businesses or business units.

An exemplary analytic framework according to embodiments of the invention includes a plurality of analytic dimensions. In certain aspects, the analytic framework provides a “sequential hierarchical model” in which the scoring for each dimension of the outsourcing decision process is tabulated based on linear hierarchical summation of ratings leading to a final score. Each dimension represents a unique unidirectional view for the business process being evaluated from an outsourcing perspective and correlates to an individual rating or score for each dimension. In certain embodiments, ratings can be evaluated on a scale of 0-5. In certain embodiments, each dimension is constituted by elements called “factors” and sub-elements called “parameters.” Factors and parameters can be used to distinguish the unique features of a dimension, which can be collectively exclusive but not exhaustive. Additional factors and parameters can be added to the dimensions focusing on detailed evaluation of the unique characteristics of a business process.

According to certain embodiments, three dimensions are provided: risk, readiness, and return. The risk dimension reflects possible inhibitors or “road blocks” in connection with outsourcing a business process. The readiness dimension reflects the ease at which a business can outsource a business process. The reward dimension reflects the possible benefit to a business to be obtained from outsourcing a business process. In certain embodiments, values in any of the three dimensions can be scaled such that the value provides a “score.” In one embodiment, example, an exemplary scale can be from one (1) to five (5), such that there can be a risk score from 1-5, a readiness score from 1-5, and a return score from 1-5. Any of these scores can be referred to as a “dimension score” herein. In other embodiments, however, different scales and scoring methodologies can be implemented according to the analytic framework of the present invention, some of which may be understood by those having skill in the alt.

The analytic framework described herein therefore can advantageously allow enhanced (e.g., objective, consistent, and repeatable model) prioritization of selecting business processes for outsourcing. For an exemplary business process, each of the risk score, the readiness score, and the return score can be used to prioritize outsourcing opportunities for that exemplary business process. A first-level priority (“Priority I”) can be assigned for business processes that, according to the analytic framework, have a favorable score in all dimensions (i.e., low risk score, high readiness score, and high return score). A second-level priority (“Priority II”) can be assigned for business processes that, according to the analytic framework, have a favorable risk score and a favorable score in only one other dimension (i.e., low risk score, low readiness score, and high return score; or low risk score, high readiness score, and low return score). A third-level priority (“Priority III”) can be assigned for business processes that, according to the analytic framework, have a favorable score in only two dimensions excluding risk (i.e., high risk score, high readiness score, and high return score. A fourth-level priority (“Priority IV”) can be assigned for business processes that, according to the analytic framework, have a favorable score in less than two dimensions (e.g., low risk score, low readiness score, and low return score. Such a prioritization advantageously allows business-process owners to implement a corresponding timeframe for outsourcing activities. For example, Priority I business processes can relate to a near-term initiative (e.g., 1-18 months). Further, for example, Priority II business processes can relate to a medium-term initiative (e.g., 18-36 months). Further, for example, Priority III and IV business processes can relate to a long-term initiative (e.g., 18-36 months).

In further aspects, the analytic framework described herein can advantageously provide for (a) enhanced planning and preparation for outsourcing activities and (b) a metric for selecting business processes for outsourcing. For an exemplary business process, each of the risk score and the readiness score can be used to categorize outsourcing opportunities, for that exemplary business process, into one of four categories including: “consider outsource,” “improve,” “go slow,” and “retain,” According to certain embodiments, a recommendation is provided according to the categorization described above. According to further embodiments, a recommendation is provided according to such categorization in conjunction with a priority level also described above. For example, a recommendation may be to “improve” a business process for suitability for outsourcing. In other embodiments, a recommendation may be to “improve” a business process as a near-term initiative (e.g., 1-18 months).

In more particular aspects, business processes having low risk score and low readiness score can correlate to an “improve” recommendation. A business-process owner, in response to an “improve” recommendation can undertake, for example, a PIP (“Performance Improvement Plan”) to improve the readiness of the service towards outsourcing. For example, the PIP can address any of the factors contributing to the low readiness score. Factors contributing to a low readiness score can be identified according to various embodiments, some of which are described further herein. Also, business processes having high risk score and low readiness score can correlate to a “retain” recommendation. A business-process owner, in response to a “retain” recommendation can undertake, for example, an individual assessment of the risk factors involved in such processes, and activities to mitigate these risk factors can be planned. Also, in response to a “retain” recommendation, a business-process owner can undertake, for example, a PIP (“Performance Improvement Plan”) to improve the readiness of the service towards outsourcing. For example, the PIP can address any of the factors contributing to the low readiness score. Risk factors contributing to a high risk score can be identified according to various embodiments, some of which are described further herein. Also, in more particular aspects, processes having a high risk score and a high readiness score can correlate to a “go slow” recommendation. A business-process owner, in response to a “go-slow” recommendation can undertake, for example, an individual assessment of the risk factors involved in such processes, and activities to mitigate these risk factors can be planned. Also, in more particular aspects, processes having low risk score and high readiness score can correlate to a “consider for outsource” recommendation. A business-process owner, in response to a “consider for outsource” recommendation can undertake, for example, further deliberation regarding the ultimate decision to outsource while focusing on other factors, including, for example, market readiness, maturity levels in service (e.g., KPIs), cultural reasons outsource operational model, etc.

The strategic framework can therefore provide an enhanced evaluation of business processes that is objective, uniform, and repeatable for any business process irrespective of department. The evaluation is objective, for example, in that it can be beneficially linked to substantiated data on the dimensional level, in three dimensions. In further detail, data on the dimensional level in any dimension can be broken down into data on the factor level for that dimension. And in even further detail, data on the factor level for any dimension can be broken down into data on the parameter level for that factor. And in even further detail, data on the parameter level can be obtained from responses to standardized questions relating to that parameter. The hierarchy of dimensions, factors, parameters, and questions/responses is further described herein with reference to the attached figures. Advantageously, the strategic framework advantageously allows for the collection, organization, and presentation of data that business-process owners can use to better understand the outsourcing recommendations and to prioritize and plan for the undertaking of activities relating to outsourcing, including, for example, data relevant to a PIP (“Performance Improvement Plan”), an individual assessment of the risk factors and mitigation of risk factors, deliberation focusing on market readiness, maturity levels in service (e.g., KPs), cultural reasons outsource operational model, etc.

The enhanced appraisal is also uniform and objective with respect to providing an appraisal of a business process over time, such as to monitor its progress towards candidacy for outsourcing. The evaluation is uniform, for example, in that it can yield results across different business processes that can be compared using a uniform metric. In further detail, the dimensions of risk, readiness, and return are applicable regardless of the business process. Factors and parameters relating to each of these dimensions, which are described below, may also be applicable regardless of the business process. The evaluation is repeatable, for example, in that the analytic framework provides a consistent structure that can be applied to for a business process several times over a period of time and that differences in the results are significant and measurable. Accordingly, a business process owner can, over time, to monitor the progress of a business process towards candidacy for outsourcing in real terms. Accordingly, the strategic framework can be applied on a continuous (periodic) basis to determine which business processes are suitable for outsourcing or to determine which business processes are better completed internally. For example, process owners can take appropriate mitigation steps to reduce risk or increase readiness and a business process can score differently as progress is made.

Any of the above mentioned dimension scores can be based on a plurality of factors. The relationship between any of the plurality of factors and the overall core can be analyzed by process owners, for example, in determining which factors should be addressed to improve the respective score. In certain embodiments, a risk score can be based on a plurality of risk factors. For example, the plurality of risk factors can include the following factors: compliance risk, core, criticality, volatility, and complexity. Also in certain embodiments, a readiness score can be based on a plurality of readiness factors. For example, the plurality of readiness factors can include the following factors: internal, market, maturity, stability, and documentation. Also in certain embodiments, a return score can be based on a plurality of return factors. For example, the plurality of return factors can include the following factors: business-specific, cost containment, satisfaction, and performance. Any of the above mentioned factors can be based on a plurality of parameters. The relationship between any of the plurality of parameters with respect to a particular factor can be analyzed by process owners, for example, in determining the root cause or the target action for improving the respective score.

In more particular aspects, embodiments can include computer-implemented methods and non-transitory computer-readable media to generate an outsourcing questionnaire interface to be displayed at a display of a computing device. In certain embodiments, the outsourcing questionnaire interface can include a plurality of risk questions and a corresponding plurality of risk response-fields, a plurality of readiness questions and a corresponding plurality of readiness response-fields, and a plurality of return questions and a corresponding plurality of return response-fields.

Also, in more particular aspects, embodiments can include computer-implemented methods and non-transitory computer-readable media to determine a risk score for a business process responsive to a plurality of user-selected risk responses relating to the business process received at the plurality of risk response-fields, determine a readiness score for the business process responsive to a plurality of user-selected readiness responses relating to the business process received at the plurality of readiness response-fields, and determine a return score for the business process responsive to a plurality of user-selected return responses relating to the business process received at the plurality of return response-fields.

Further, in more particular aspects, embodiments can include computer-implemented methods and non-transitory computer-readable media to generate an outsourcing recommendation interface, to be displayed at a display of a computing device. In certain embodiments, the outsourcing recommendation interface can be a graphical chart including a process-recommendation bubble for the business process. Further, in certain embodiments, the process-recommendation bubble can be displayed at a position in the graphical chart responsive to each of the risk score and the readiness score and displayed of a size in the graphical chart responsive to the return score for the business process.

Aspects include a computer-readable program product stored in a non-transitory tangible computer-readable storage medium to provide one or more graphical outsourcing recommendations for a business process to a user of a computing device having a display, the non-transitory tangible computer-readable storage medium characterized in that the medium having stored thereon a set of executable instructions that when executed by a computer system cause the computer system to perform operations including: 1) generate an outsourcing questionnaire interface, to be displayed at a display of a computing device, the outsourcing questionnaire interface including a plurality of risk questions and a corresponding plurality of risk response-fields, a plurality of readiness questions and a corresponding plurality of readiness response-fields, and a plurality of return questions and a corresponding plurality of return response-fields; 2) determine a risk score for a business process responsive to a plurality of user-selected risk responses relating to the business process received at the plurality of risk response-fields; 3) determine a readiness score for the business process responsive to a plurality of user-selected readiness responses relating to the business process received at the plurality of readiness response-fields; 4) determine a return score for the business process responsive to a plurality of user-selected return responses relating to the business process received at the plurality of return response-fields; and 5) generate an outsourcing recommendation interface, to be displayed at a display of a computing device, the outsourcing recommendation interface recommending whether to outsource the business process responsive to each of the risk score and the readiness score and indicating the return score for the business process.

Aspects include a computer-implemented method to provide one or more graphical outsourcing recommendations for a business process to a user of a computing device having a display, the computer-implemented method including the steps of: 1) generating an outsourcing questionnaire interface, to be displayed at a display of a computing device, the outsourcing questionnaire interface including a plurality of risk questions and a corresponding plurality of risk response-fields, a plurality of readiness questions and a corresponding plurality of readiness response-fields, and a plurality of return questions and a corresponding plurality of return response-fields; 2) determining a risk score, a readiness score, and a return score for a business process responsive to a plurality of user-selected risk responses relating to the business process received at the plurality of risk response-fields, a plurality of user-selected readiness responses relating to the business process received at the plurality of readiness response-fields, and a plurality of user-selected return responses relating to the business process received at the plurality of return response-fields; and 3) generating an outsourcing recommendation interface, to be displayed at a display of a computing device, responsive to determining each of the risk score, the readiness score, and the return score for the business process, the outsourcing recommendation interface being a graphical chart having a coordinate space defined by a first axis and a second axis. The graphical chart can include: a) four recommendation quadrants of the coordinate space, each of the four recommendation quadrants being indicative of a corresponding outsourcing recommendation, and b) a process-recommendation bubble for the business process being displayed at a position in the coordinate space responsive to each of the risk score and the readiness score and having a surface area responsive to the return score, the process-recommendation bubble intersecting one or more of the four recommendation quadrants to provide a graphical outsourcing recommendation for the business process to a user, when viewing the display, corresponding to the intersected recommendation quadrants.

Aspects include a system for analyzing for performing outsourcing analyses and outputting results on a display, the system including: a server computing device; and a client computing device having a display and user interface, the client computing device being communicatively coupled to the server computing device via a network, the server computing device and client computing device being operative to perform the above-described method to present the result on of an outsourcing analysis on the display.

### BRIEF DESCRIPTION OF THE DRAWINGS

So that the manner in which the features and benefits of the invention, as well as others which will become apparent, may be understood in more detail, a more particular description of the embodiments may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1A includes a schematic flow chart for the generation, presentation, and use of various graphical user interfaces according to certain embodiments.

FIG. 1B includes a schematic flow chart for the generation, presentation, and use of an outsourcing questionnaire interface, in particular focusing on data flow, according to certain embodiments.

FIG. 1C includes a schematic flow chart for the generation, presentation, and use of an outsourcing questionnaire interface, in particular focusing on data flow, according to certain embodiments.

FIG. 2A includes a tree diagram showing the hierarchical relationship of dimensional data, such as dimensions, factors, parameters, and questions, according to certain embodiments.

FIG. 2B includes a tree diagram showing the hierarchical and mathematical relationship of dimensional data, such as dimension scores, factor scores, parameter scores, and question scores, according to certain embodiments.

FIG. 3A includes a tree diagram showing the hierarchical relationship of example dimensional data for a risk dimension, such as example factors and example parameters, according to certain embodiments.

FIG. 3B includes a tree diagram showing the hierarchical relationship of example dimensional data for a readiness dimension, such as example factors and example parameters, according to certain embodiments.

FIG. 3C includes a tree diagram showing the hierarchical relationship of example dimensional data for a return dimension, such as example factors and example parameters, according to certain embodiments.

FIG. 4A includes a schematic diagram of various devices, modules, and networks according to certain embodiments.

FIG. 4B includes a schematic data-flow diagram among various devices, modules, and networks according to certain embodiments.

FIG. 5A includes a schematic architecture diagram of various systems and devices according to certain embodiments.

FIG. 5B includes a schematic architecture diagram of various systems and devices according to certain embodiments.

FIG. 6 includes a flow chart diagram of various computer-implemented methods according to certain embodiments.

FIG. 7 includes a flow chart diagram of various computer-implemented methods according to certain embodiments.

FIG. 8 includes a flow chart diagram of various computer-implemented methods according to certain embodiments.

FIG. 9 includes a flow chart diagram of various computer-implemented methods according to certain embodiments.

FIG. 10A includes a schematic diagram of various instructions of one or more computer-readable media according to certain embodiments.

FIG. 10B includes a schematic diagram of various instructions of one or more computer-readable media according to certain embodiments.

FIG. 11 includes a schematic representation of an example user interface according to certain embodiments.

FIG. 12 includes a schematic representation of an example user interface according to certain embodiments.

FIG. 13 includes a schematic representation of an example user interface according to certain embodiments.

FIG. 14 includes a schematic representation of an example user interface according to certain embodiments.

FIG. 15 includes a schematic representation of an example user interface according to certain embodiments.

While the invention is susceptible to various modifications and alternative forms, specific embodiments thereof are shown by way of example in the drawings and will herein be described in detail. In the drawings and description that follow, like parts are marked throughout the specification and drawings with the same reference numerals, respectively. Prime notation, if used, indicates similar elements in alternative embodiments. The drawings are not necessarily to scale. Certain features of the disclosure may be shown exaggerated in scale or in somewhat schematic form and some details of conventional elements may not be shown in the interest of clarity and conciseness. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

The present invention will now be described more fully hereinafter with reference to the accompanying drawings, which illustrate various embodiments of the invention. This invention, however, may be embodied in many different forms and should not be construed as limited to the embodiments set forth herein. Rather, these embodiments are provided so that this disclosure will be thorough and complete, and will fully convey the scope of the invention to those skilled in the art. It is to be fully recognized that the different teachings of the various embodiments discussed below may be employed separately or in any suitable combination to produce desired results. The various characteristics mentioned above, as well as other features and characteristics described in more detail below, will be readily apparent to those skilled in the art upon reading the following detailed description of the various embodiments, and by referring to the accompanying drawings.

Embodiments of the present invention provide systems, methods, and computer-readable media to provide graphical outsourcing recommendations to users. In certain embodiments, users provide responses to questions with respect to business processes. Each of the questions relate to one of a plurality of dimensions. The graphical outsourcing recommendations are based on the responses provided by the users as they relate to one or more of the plurality of dimensions. In further embodiments, each of the questions relate to one or more of a plurality of factors relating to one of the plurality of dimensions. In even further embodiments, each of the questions relate to one or more of a plurality of parameters, which relate to one or more of a plurality of factors relating to one of the plurality of dimensions.

According to various embodiments, one or more graphical outsourcing recommendations are generated responsive to one or more dimension scores. In certain embodiments, the provided responses relate to a response score, which contributes, at least in part, to the determination of one or more dimension scores. In further embodiments, each of the response scores contribute, at least in part, to the determination of one or more of a plurality of factor scores; and each factor score contributes, at least in part, to the determination of one or more of a plurality of dimension scores. In even further embodiments, each of the response scores contribute, at least in part, to the determination of one or more of a plurality of parameter scores; and each parameter score contributes, at least in part, to the determination of one or more of a plurality of factor scores.

As is described further herein, various embodiments of systems, methods, and computer-readable media are described herein, some of which provide for the presentation of such questions to a user, the receipt of such responses from a user, the determination of such scores, or the presentation of such recommendations to a user. In further embodiments, as are described herein, other data and information relating to business processes and outsourcing recommendations can be collected, organized, and displayed to a user. Not all embodiments, however, provide for the presentation of such questions to a user, the receipt of such responses from a user, the determination of such scores, and the presentation of such recommendations to a user.

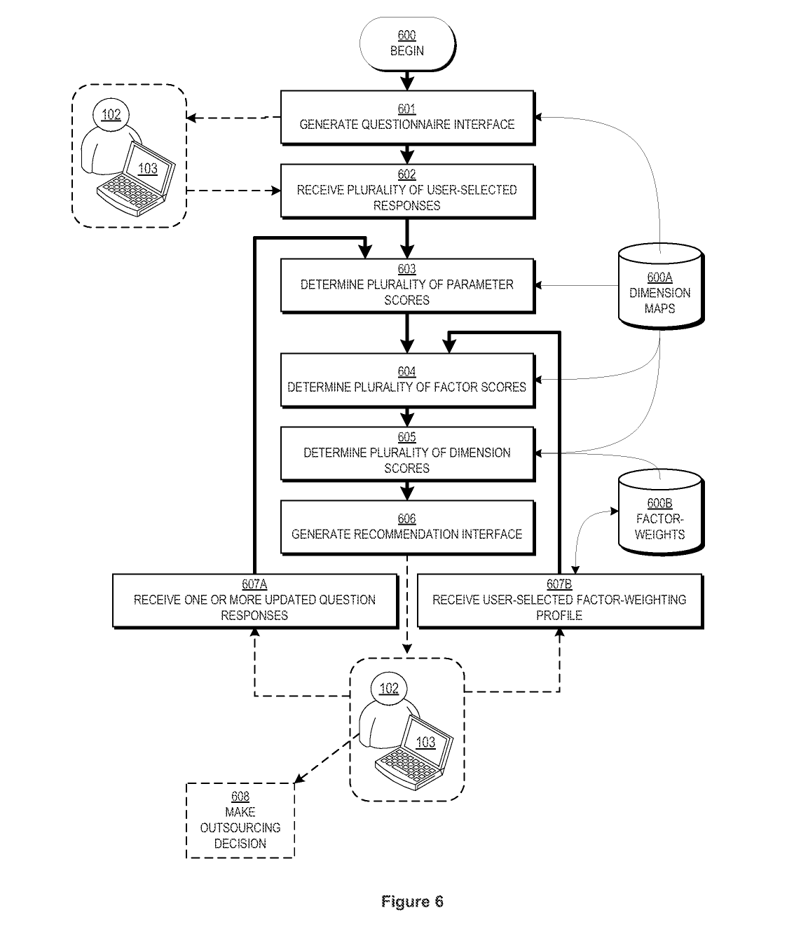

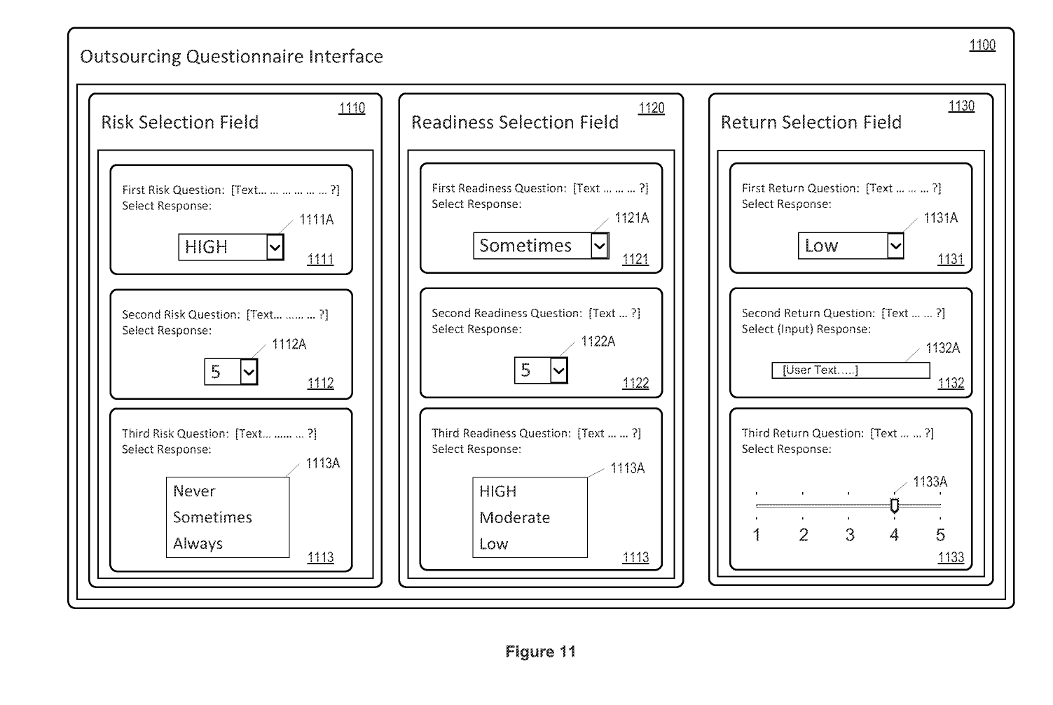

General functional aspects of an outsourcing questionnaire interface and an outsourcing recommendation interface, according to certain embodiments, can be described briefly with reference to schematic representations of an outsourcing questionnaire interface (140, 150) and a schematic representation of an outsourcing-recommendation interface (160) in FIG. 11. According to certain embodiments, in a first process (131), the outsourcing questionnaire interface (140) can be generated responsive to data from dimension maps (132) for a plurality of dimensions, e.g., data that relates to questions for a dimension. At the outsourcing questionnaire interface (140), a plurality of questions each corresponding to a dimension of the plurality of dimensions, e.g., question (141) corresponding to dimension (142), can be presented to a user (102) when viewing the outsourcing questionnaire interface (140). Other questions can be provided for other dimensions, e.g., dimensions (143, 144). Although only one question is shown for each dimension, embodiments can provide a plurality of questions for each dimension, including a plurality of questions for each of a plurality of factors for each dimension, as is described further herein. As is shown in a different schematic depiction of the outsourcing questionnaire interface (150), the user (102) can enter one or more user-selections, e.g., user-selection (152), with respect to a corresponding question, e.g., question (141). More particular aspects of outsourcing questionnaire interfaces, according to various embodiments, are described further herein, for example, with respect to FIG. 11. More particular aspects of processes to generate outsourcing questionnaire interfaces, according to various embodiments, are described further herein, for example, with respect to FIGS. 6, 7, 8, and 9.

Further, according to various embodiments, in a second process (133), user-selections from the outsourcing questionnaire interface (150) can be received, and a separate score can be determined, for each dimension to which any of the questions corresponds, e.g., dimensions (142, 143, 144) for user-selections (152, 153, 154). Although only one user-selection is shown for each dimension, embodiments can provide a plurality of user-selections for each dimension (e.g., for a plurality of questions for each dimension), including a plurality of user-selections for each of a plurality of factors for each dimension, as is described further herein. According to various embodiments, each of the plurality of scores, e.g., scores (136, 137, 138) corresponding to dimensions (142, 143, 144), can be determined responsive to mathematical relationships set forth in the dimension maps (132) for the respective dimension and further responsive to factor weightings set forth in the factor-weighting profiles (134) for the respective dimension. More particular aspects of processes to determine a plurality of dimension scores, according to various embodiments, are described further herein, for example, with respect to FIGS. 6, 7, 8, and 9.

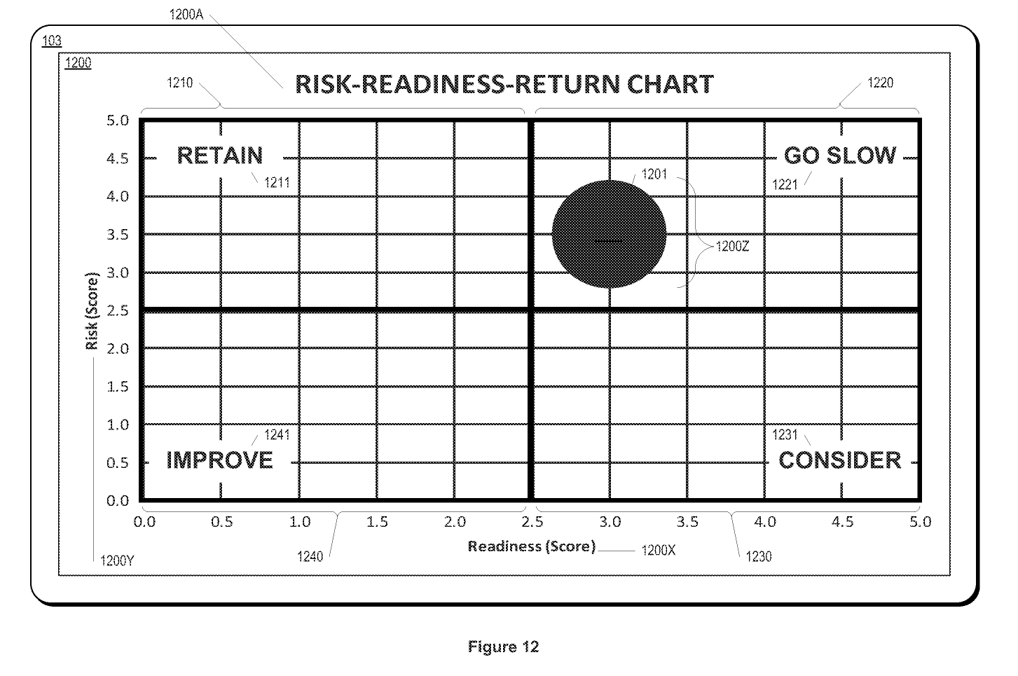

Further, according to various embodiments, in a third process (135), an outsourcing recommendation interface (160) can be generated responsive to the plurality of scores (136, 137, 138). For example, the outsourcing recommendation interface can include a multidimensional chart (161), which can include a process-recommendation bubble (161A). The process-recommendation bubble (161) can be positioned in or among any of four quadrants (161B, 161C, 161D, 161E) along an x-axis and along a y-axis. For example, the score (136) for one dimension (142) can correspond to the position (162) of the process-recommendation bubble (161) on the x-axis. Also, for example, the score (137) for another dimension (143) can correspond to the position (163) of the process-recommendation bubble (161) on the y-axis. The process-recommendation bubble (161) can further be sized (e.g., as a third dimension) in or among any of the four quadrants. For example, the score (138) for another dimension (144) can correspond to the size (164) of the process-recommendation bubble (161). Although only one process-recommendation bubble is shown, embodiments may include a plurality of process-recommendation bubbles according to different dimension maps, factor-weighting profiles, or user-selections. More particular aspects of outsourcing recommendation interfaces, according to various embodiments, are described further herein, for example, with respect to FIGS. 12, 13, and 14. Also, more particular aspects of processes to generate outsourcing recommendation interfaces, according to various embodiments, are described further herein, for example, with respect to FIGS. 6, 7, 8, and 9.

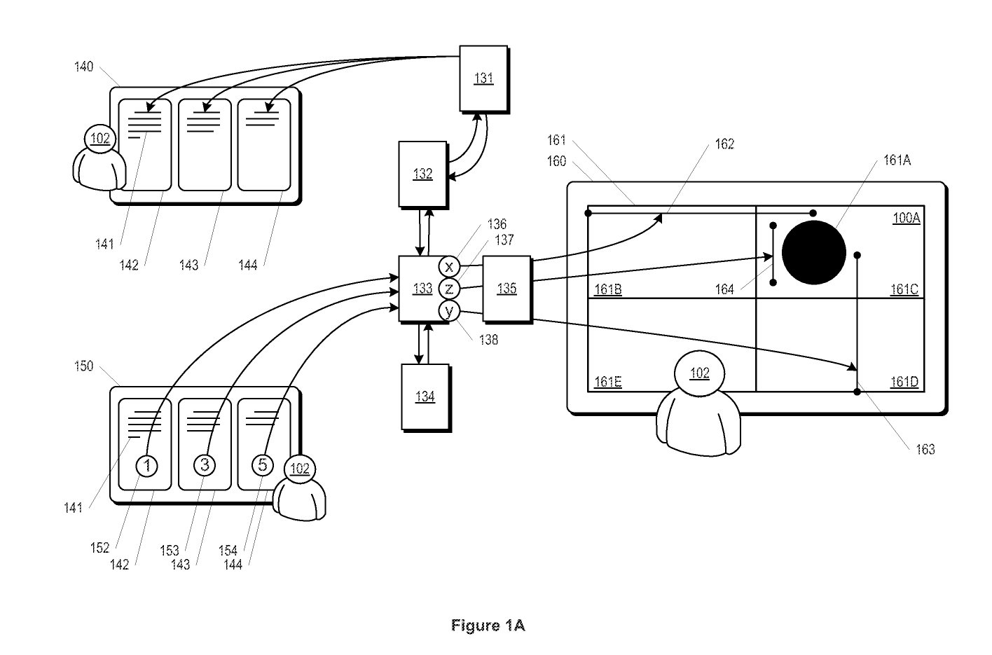

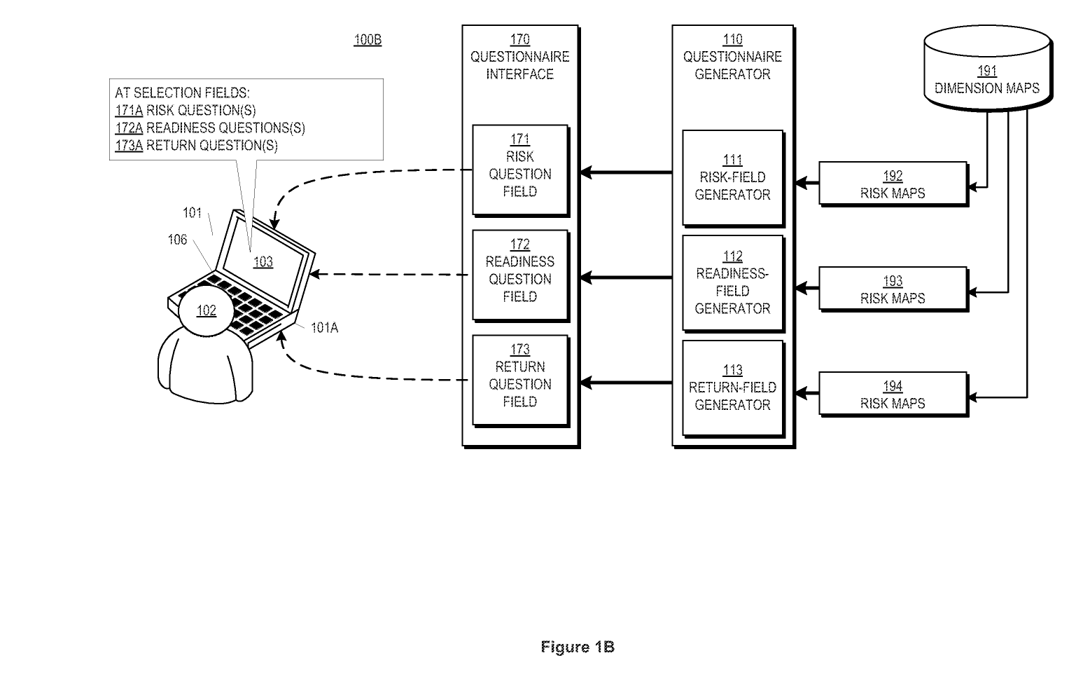

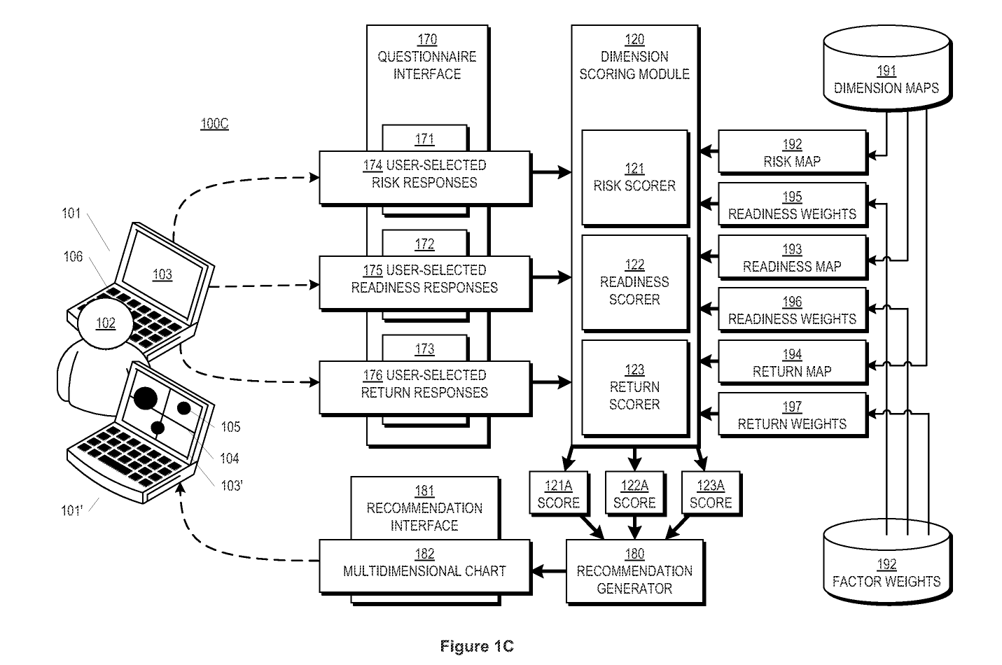

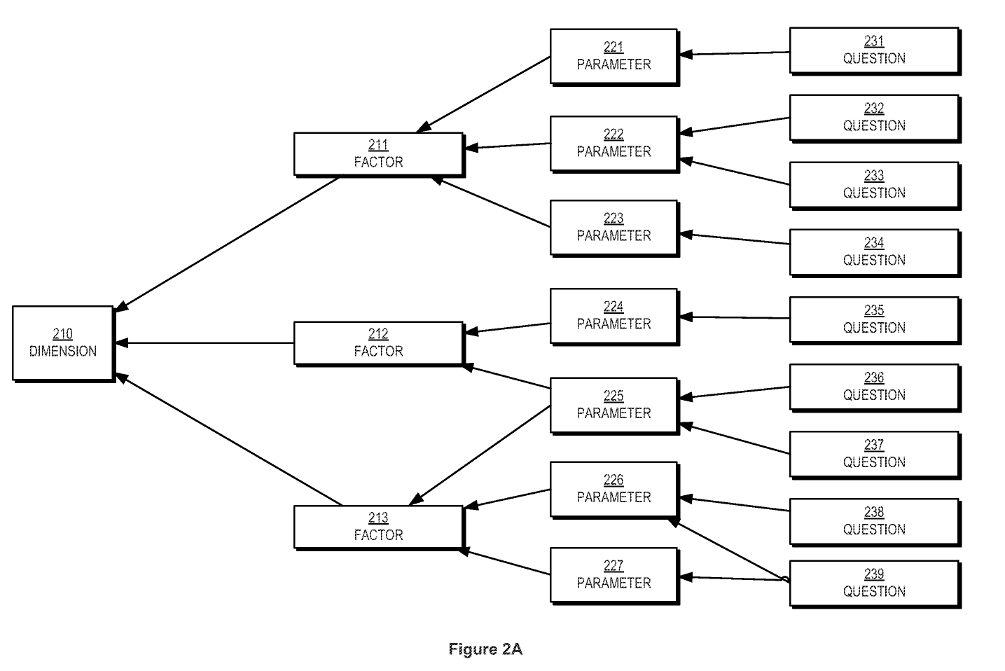

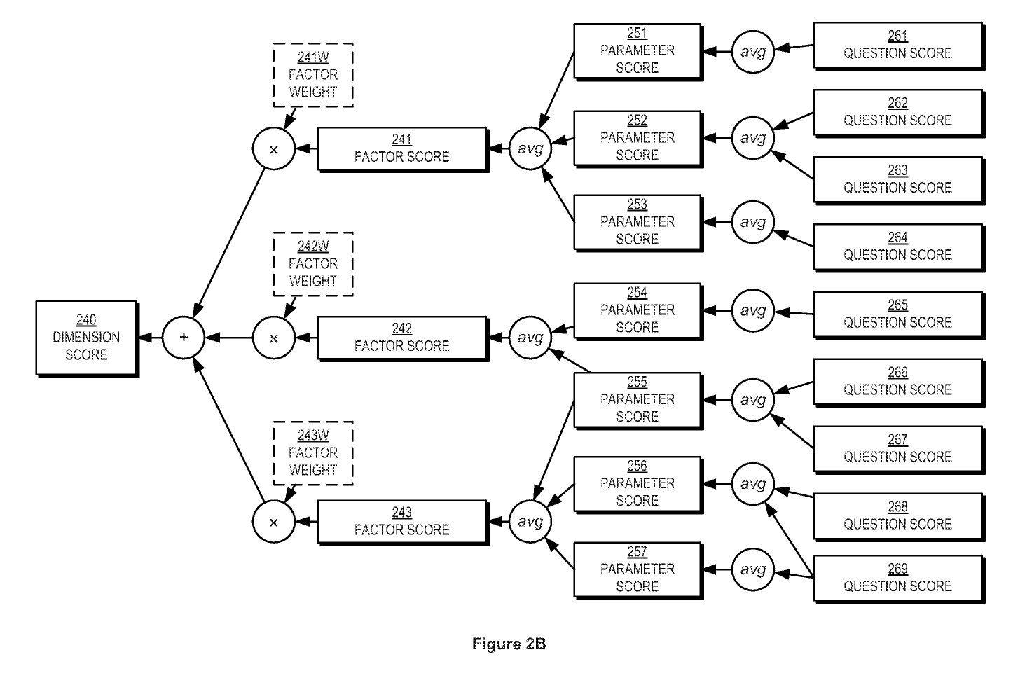

Various examples of embodiments are described in more general aspects with reference to FIGS. 1B, 1C, 2A, and 2B. Other embodiments may also be described below in more general aspects or more particular aspects with reference to other drawings. In one example of an embodiment of a system (100B) depicted in FIG. 113B, a user (102) of a client device (101) may interact with an outsourcing questionnaire interface (170) being displayed on a display (103) of the client device (101). The outsourcing questionnaire interface (170) can include, for example, a plurality of questions, each of which relates to a dimension. In the example provided by FIGS. 1B and 1C, the dimensions include a risk dimension, a readiness dimension, and a return dimension. In some embodiments, the relationship between one or more questions and a dimension is provided by one or more dimension maps for the particular dimension, some of which are illustrated as the risk map (192), the readiness map (193), and the return map (194).

In further detail, examples of relationships provided in dimension map can be shown with reference to FIG. 2A. In various embodiments, a dimension map provides the relationship between a dimension and a plurality of questions. The relationship can include one or more factors for the dimension as well as one or more parameters for each factor. By way of example, a dimension map may relate one or more questions to one or more parameters, one or more parameters to one or more factors, and one or more factors to a dimension.

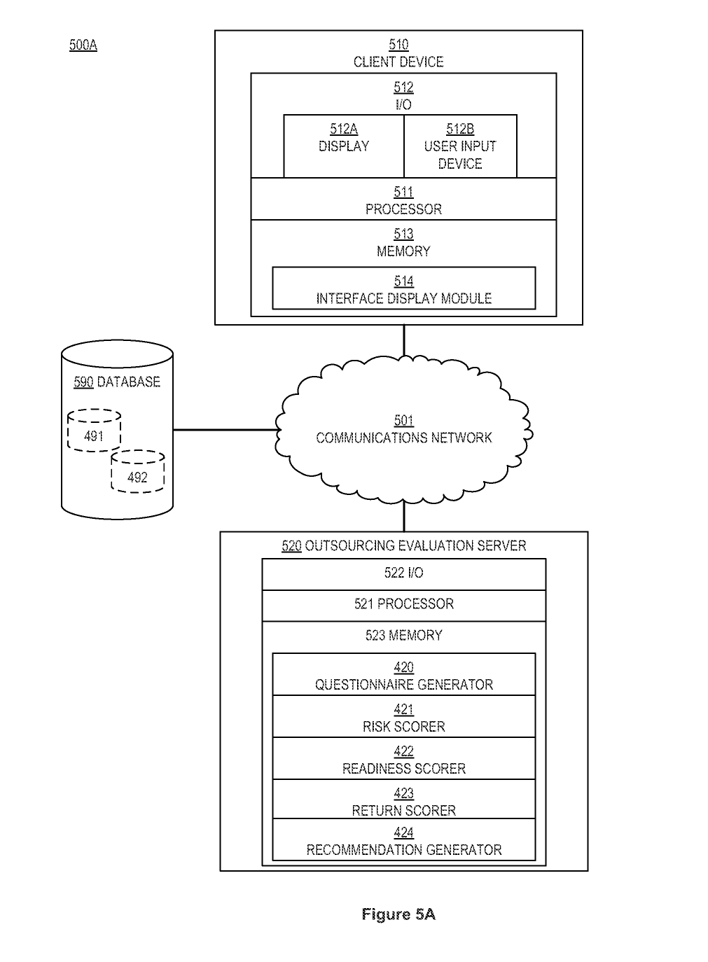

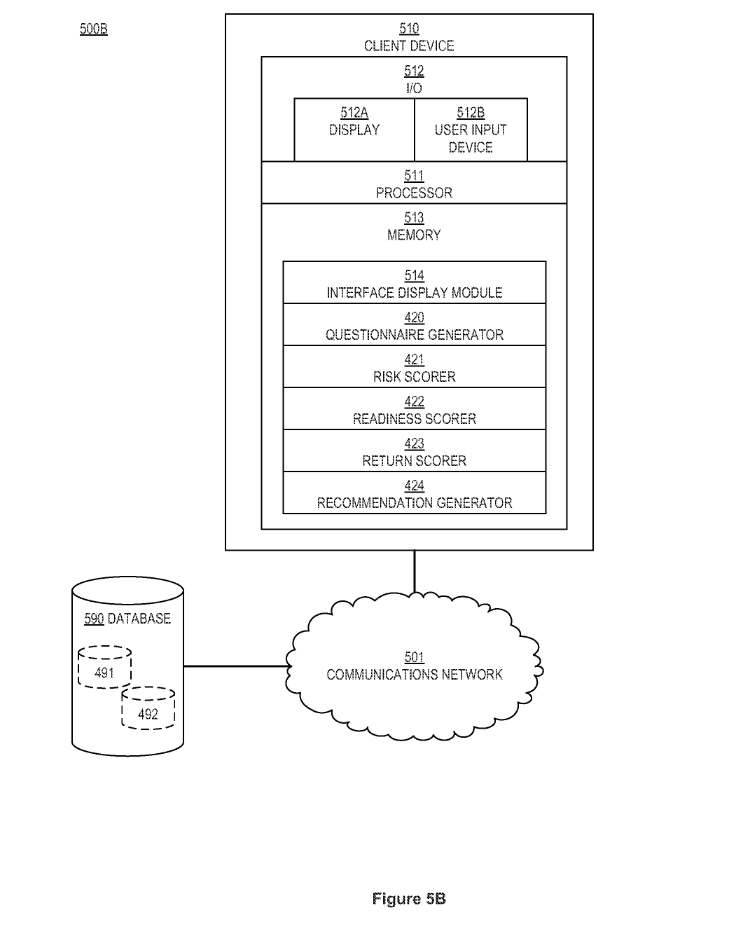

In FIG. 2A, for example, one question (231) relates to a particular parameter (221); one or more other questions (232, 233) relates to another particular parameter (222); and one other question (234) relates to a another particular parameter (223). Further, each of the above parameters (221, 222, and 223) relate to one particular factor (211), which relates to a particular dimension (210). In certain embodiments, one question can relate to more than one parameter, as is shown with reference to question (239) and parameters (223, 227). Also, in certain embodiments, one parameter can relate to more than one factor, as is shown with reference to parameter (225) and factors (212 and 213). The exemplary structure map set forth above is generally applicable for different questions, different parameters, different factors, and different dimensions, examples of which are identified and described further herein, including, for example those dimensions, factors, and parameters described herein with reference to FIGS. 5A, 5B, and 5C.

In more particular aspects, the outsourcing questionnaire interface (170) can include one or more user-selection fields, by which users can make selections (e.g., responses) with respect to certain questions. According to various embodiments, each user-selection field can correspond to a different dimension. As is shown in FIG. 1B, a risk selection field (171) is provided for the risk dimension, a readiness selection field (172) is provided for the readiness dimension, and a return selection field (173) is provided for the return dimension. Each user-selection field can include one more questions and one or more response fields for each of the one or more questions. Collectively, the one or more user-selection fields for the one or more dimensions can be referred to as an “outsourcing questionnaire.” By way of example, a risk selection field (171) can include one or more risk questions (171A). Also, a readiness selection field (172), for example, can include one or more readiness questions (172A). And further, a return selection field (173), for example, can include one or more return questions (173A).

The outsourcing questionnaire interface (170) can be generated, for example, by a questionnaire generator (110), in more particular aspects, the questionnaire generator (110) can generate a risk selection field (171), a readiness selection field (172), and a return selection field (173). In certain embodiments, the questionnaire generator (110) can include, for example one or more dimension-specific field generators, for instance, a risk-field generator (111), a readiness-field generator (112), and a return-field generator (113). In even more particular aspects, according to certain embodiments, the risk-field generator (111) can generate the risk selection field (171), the readiness-field generator (112) can generate the readiness selection field (172), and the return-field generator (113) can generate the return selection field (173).

Each of the risk selection field (171), the readiness selection field (172), and the return selection field (173) can be generated responsive to a corresponding dimension map, such as the risk map (192), the readiness map (193), and the return map (194), respectively. For instance, each of the questions in the respective dimension map can be used to generate the questions in the respective selection fields. In certain embodiments, questions can be stored in the dimension maps, for example, as text. In other embodiments, questions can be referenced in the dimension maps but stored separately (e.g., in a remotely accessible memory).

The outsourcing questionnaire interface (170), when presented on the display (103) of the client device (101), allows the user (102) of the client device (101) to make one or more user-selections (e.g., responses) at one or more of the selection fields, for instance, the risk selection field (171), the readiness selection field (172), and the return selection field (173). Each of the user-selections can be a response to a corresponding question, and each response can correlate to a score. For example, in some embodiments, scores are provided within a range of 1-5, with 5 being the highest score and 1 being the lowest score. Such values are referred to herein as question scores or response scores. As is described further here, such question scores may contribute, at least in part, to the determination of a dimension score (e.g., a risk score, a readiness score, and a return score).

As can be shown with respect to system (100C) in FIG. 1C, the user (102) can use the user-input device (106) to select (e.g., input) one or more responses at the outsourcing questionnaire interface (170). One or more user-selected responses, for example, can be selected for each of the user-selection fields. In more particular aspects, the user (102) can select a response corresponding to a particular question at a corresponding response field of one of the selection fields. For example, one or more user-selected risk response (174) can be selected at the risk selection field (171), one or more user-selected readiness response (175) can be selected at the readiness selection field (172), and one or more user-selected return response (176) can be selected at the return selection field (173). Each of the one or more user-selected risk responses (174), user-selected risk responses (175), and user-selected risk responses (176) can be transmitted by client device (101), through the outsourcing questionnaire interface (170), to a dimension scoring module (120), which can be configured to generate a plurality of dimension scores responsive to the user-selected responses received.

The dimension scoring module (120) can be configured to receive the responses described above and to determine a dimension score for one or more dimensions. The dimension scoring module (120) can calculate a dimension score responsive to a dimension map for a particular dimension and further responsive to the responses relating to that particular dimension. In more particular aspects, each dimension score can be determined responsive to specific relationships with the one or more responses (e.g., a response score) as is set forth in a dimension map stored in a dimension map repository (191). The relationship between a response score and a dimension score can include, for example, factoring in specific weightings as may be relevant to different factors of the dimension. Specific weightings for different factors of a particular dimension can be specified in a factor-weighting profile for that particular dimension, which may be stored in a factor-weights repository (192). Further, the dimension scoring module (120) can be configured to return one or more dimension scores to a recommendation generator module (180) so that information indicative of the dimension scores can be presented to a user. IN other embodiments, the dimension scoring module can be configured to return one or more dimension scores to a process prioritizer (not shown) so that processes can be prioritized as may be relevant to a user.

As is described above, different dimensions, factors, parameters, and questions may be related according to relationships defined in a dimension map. In more specific aspects, such relationships can include one or more mathematical relationships, i.e., algorithms, to determine various scores relating thereto, including, for example, one or more dimension scores, one or more factor scores, and one or more parameter scores. Each of the foregoing scores can be determined responsive to such mathematical relationships in response to user-selected responses or response-scores relating thereto. Examples of mathematical relationships between response scores, parameter scores, factor scores, and a dimension score can be shown with reference to the dimension map illustrated in FIG. 2B.

Each of the question scores for questions relating to a particular parameter can be averaged to define a parameter score for that parameter. For example, in FIG. 2B, one or more question scores for respective questions, such as question scores (261, 262, and 263) can be averaged in determining one or more parameter scores for respective parameters, such a parameter scores (251, 252). For example, in FIG. 2B, question scores (262 and 263) are averaged in determining parameter score (252). Likewise, for example, question score (261), as the only question for the respective parameter, is also the parameter score (251) for the respective parameter. Each of the parameter scores for parameters relating to a particular factor can be averaged to define a factor score for that factor. For example, in FIG. 2B, parameter scores (251, 252, 253) can be averaged in determining factor score (241). Each of the factor scores for factors relating to a particular dimension can be averaged to define a dimension score for that dimension. For example, in FIG. 2B, factor scores (241, 242, 243) can be averaged in determining dimension score (240). In certain embodiments, dimension scores can be determined using a weighted sum. For example, in FIG. 2B, factor weights (241W, 242W, 243W) can be applied to factor scores (241, 242, 243), respectively, in determining dimension score (240). In certain embodiments, the factor weights can sum to 1.00, with individual factor weights being provided to reflect the relative importance of a particular factor in the determination of the dimension score. Accordingly, the product of each of the factor scores (241, 242, 243) and their respective factor weights (241W, 242W, 243W) can be summed to provide the weighted average dimension score (240). The exemplary structure map set forth above may be applicable for different questions, different question scores, different parameters, different parameter scores, different factor weights, different factors, different factor scores, different dimensions, and different dimension scores according to various techniques, some of which are described further herein, including, for example those dimensions, factors, and parameters described herein with reference to FIGS. 5A, 5B, and 5C.

Accordingly, the structure of the dimension maps can allow a uniform evaluation model, for example, establishing each dimension as a function of one or more factors, each factor as a function of one or more parameters, and each parameter as a function of one or more questions. According to various embodiments, different dimension maps can be provided and each factor, parameter, and question therein can be customized according to different considerations (e.g., differing institutional considerations). Advantageously, different dimension maps can be used to modulate the substance of the evaluation while maintaining the uniformity of the evaluation model. Embodiments of the invention are therefore portable to different institutions, in different industries, in different legal and regulatory environments, or subject to other differing considerations.

In more particular aspects, the dimension scoring module (120), according to various embodiments, can include, for example, each of a risk scorer module (121), a readiness scorer module (122), and a return scorer module (123), as is shown in FIG. 1C. The risk scorer module (121), for example, can be configured to determine a risk score (121A) responsive to the user-selected risk responses (174) and further responsive to the risk map (192) and the risk weights (195). Also, the readiness scorer module (122), for example, can be configured to generate a readiness score (122A) responsive to the user-selected readiness responses (175) and further responsive to the readiness map (193) and the readiness weights (196). And further, the return scorer module (123), for example, can be configured to generate a return score (123A) responsive to the user-selected return responses (176) and further responsive to the risk map (194) and the risk weights (197).

According to various embodiments, a plurality of factor weights (e.g., 241W, 242W, and 243W as shown in FIG. 2B) can be provided for each dimension. Any unique combination of factor weights can be referred to as a factor-weighting profile. In some embodiments, different factor-weighting profiles can reflect different strategies for evaluating outsourcing opportunities, including, for example aggressive factor-weighting profiles, neutral factor-weighting profiles, and conservative factor-weighting profiles.

Accordingly, each factor-weighting profile provides a prioritization model, and the factor-weights therein can be customized according to strategic considerations. The modularity of various weighting profiles in the determination of dimension scores beneficially allows implementing any one evaluation model according to various strategic objectives.

Accordingly, the structure of the factor-weighting profiles can further allow a uniform evaluation model, for example, establishing the relative importance of different factors in determining a dimension score. According to various embodiments, different factor-weighting profiles can be provided and each factor weight therein can be customized according to different considerations (e.g., differing strategic considerations). Advantageously, different factor-weighting profile can be used to modulate the strategy of the evaluation while maintaining the uniformity of the evaluation model. Embodiments of the invention are therefore portable to among different strategic outlooks, for example, which may differ according to business cycles, conditions in political environments, or conditions in the markets for labor, capital, or other resources.

The recommendation generator module (180), as shown in FIG. 1C, can be configured to generate an outsourcing-recommendation interface (181) including, for example, a multidimensional score chart (182) responsive to a plurality of dimension scores. In some embodiments, the multidimensional score chart (182) can be generated responsive to each of a risk score (121A), a readiness score (122A), and a return score (123A). The multidimensional score chart (182), for example, can relate each of a plurality of dimension scores to a certain visible region of the multidimensional score chart (182). This certain visible region can be, for example, a bubble region (105) having a position within the multidimensional chart (182). The bubble region (105) can be displayed such that the user (102), when viewing the multidimensional chart (182) on the display (103′), can view the bubble region as a basis for evaluating the recommendation for outsourcing the business process. In further detail, the bubble region (105) can be displayed at determined position within the multidimensional chart (182). In certain embodiments, the multidimensional chart (182) includes four (4) quadrants, and accordingly, the determined position of the bubble region (105) within the multidimensional chart can relate to each of: a horizontal position in or among the four quadrants (104), a vertical position in or among the four quadrants (104), and a size in or among the four quadrants (104). Each of the horizontal position, the vertical position, and the size of the bubble region (105) can be determined responsive to a different dimension score of the plurality of dimension scores.

Each of the four (4) quadrants of the multidimensional chart can relate to a different outsourcing recommendation, some of which are described further herein. In more particular aspects, the user (102), when viewing the multidimensional chart (182) on the display (103′), can view the bubble region (105) in relation to one or more of the four quadrants (104). In further aspects, a user can view the position and size of the bubble region (105) in relation to one or more of the four quadrants (104) to readily observe the outsourcing recommendation for the business process relating to the process-recommendation bubble.

Accordingly, the outsourcing-recommendation interface (181) can allow a uniform visualization model to provide one or more visual recommendations with respect to outsourcing decisions for different business processes. Each of the one or more visual recommendations can be provided by a different visual region of the display selected responsive to one or more dimension scores (e.g., three dimension scores) determined for the different business process. The outsourcing-recommendation interface (1800) thereby beneficially provides a uniform basis for presenting outsourcing recommendations for business processes, on a dimensional basis, responsive to: (a) user-selections concerning various factors and parameters; (b) pre-defined relationships between dimensions, factors, and parameters; and (c) pre-defined weighting of factors.

In certain embodiments, the user (102) can select new user-selected responses (e.g., changing initial user-selected responses, including entering new user-selected responses) after the outsourcing recommendation interface (181) is displayed. For example, a user (102) can change the initial user-selected responses after viewing the outsourcing recommendation interface (181), including, for example, the initial multidimensional chart (182) reflecting the initial user-selected responses. In response to such new user-selected responses, new dimension-scores can be determined and an updated multi-dimensional chart (182) can be displayed at the display (103). Also, in certain embodiments, the user (102) can select one or more factor-weights (e.g., changing initial factor-weights used in determining the dimension scores) after the initial outsourcing recommendation interface (181) is displayed. For example, a user (102) can change the initial factor-weights after viewing the initial outsourcing recommendation interface (181), including, for example, the multidimensional chart (182), which reflects the initial factor-weights. In response to new user-selected factor-weights, new dimension-scores can be determined and an updated multi-dimensional chart (182) can be displayed at the display (103).

Responsive to any such changes, the dimension scoring module (120) can determine one or more updated dimension scores, and the recommendation generator module (180) can generate an updated multidimensional chart (182). The updated multidimensional chart (182) can include, for example, a new bubble region (105) having a new horizontal position, a new vertical position, or a new size. The user (102), when viewing the updated multidimensional chart (182) on the display (103′), can view the new bubble region (105) in relation to the four quadrants (104) and base his evaluation of an outsourcing opportunity on his view of the updated bubble region (105) with respect to the outsourcing recommendation(s) corresponding to the updated position and the updated size of the bubble region (105) in or among the four quadrants (104). Accordingly, embodiments of the invention also provide a feedback loop to communicate how either (i) changes in user-selected responses (e.g., which reflect different process assessments), or (ii) changes in factor-weights (e.g., which reflect different strategic outlooks), effect a change in the graphical recommendations.

In some embodiments, a new bubble region can replace an initial bubble region. In other embodiments, a new bubble region can be displayed contemporaneously with the initial bubble region, such that a plurality of bubble regions can be displayed in a single multidimensional chart. Accordingly, each of the plurality of bubble regions can relate to a different set of dimension scores (e.g., a risk score, a readiness score, and a return score). Different sets of dimension scores can be provided, for example, for different user-selected responses, different dimension maps, different factor-weights, or for different business processes. Accordingly, the user (102), when viewing the single multidimensional chart (182) including a plurality of bubble regions, can compare each of the plurality bubble regions with respect to each other in comparing different recommendations. Further aspects of the chart interface (181) and the multidimensional chart (182) are described further herein, including with reference to FIGS. 11, 13, 14, and 15.

According to various examples of embodiments described or mentioned herein, information described herein can be included in data stored in a data repository, including, for example, computer-readable storage media, such as a non-transitory computer memory or multiple non-transitory computer memories as is described further herein. Data repositories can be any sort of organized collection of data in digital form, unless otherwise expressly described as limited to a particular structure herein. Data repositories may be, for example, in files or directories in a file system or according to any database model available in the art, including, for example, flat file databases, hierarchical databases, network databases, relational databases, dimensional databases, objectional databases, and other types of database models. References to data collections, data structures, or data operations herein that imply that any one type of structure or model exists shall not be interpreted to exclude any other type of structure or model for achieving the described purpose, unless expressly limited herein.

One or more data repositories described herein with reference to various embodiments includes, for example, a dimension map repository and a factor-weighting repository. The dimension map repository can include, for example, a plurality of dimension maps. Each dimension map can correlate to a dimension considered in making an outsourcing decision. Each dimension map can correlate to a set of factors comprising each dimension. Accordingly, each dimension can be reduced to a set of factors so that factors can be individually analyzed, and if needed, addressed (e.g., remediated). Each dimension map can correlate to a set of parameters contributing to each factor of the set of factors. Accordingly, each factor can be reduced to a set of parameters so that parameters can be individually analyzed, and if needed, addressed. Each dimension map can correlate to a set of questions indicative of each parameter of each set of factors. Accordingly, each parameter can be reduced to a set of questions addressing granular issues so that such granular issues can be individually analyzed, and if needed, addressed.

In more particular aspects, various embodiments herein can relate to a risk dimension. As is described above, the risk dimension can relate to a plurality of risk factors, and one or more dimension maps may establish such relationships. In certain embodiments, for example, a risk dimension map can relate one or more of the following risk factors to the risk dimension (510) as is shown in FIG. 5a: a core factor (511), a complexity factor (512), a criticality factor (513), a volatility factor (514), and a compliance risk factor (515). Some embodiments may relate some but not all of these risk factors to the risk dimension, and other embodiments may relate to other risk factors not specifically described herein, as other factors relating to the risk dimension may become apparent to those having skill in the art. As is also described above, the risk dimension and one or more risk factors can relate to a plurality of risk parameters, and one or more dimension maps may establish such relationships. In certain embodiments, for example, a risk dimension map can relate one or more of the following risk parameters to the risk factors as is shown in FIG. 5a. Some embodiments may relate some but not all of the following risk factors to the following risk parameters, and other embodiments may relate to other risk parameters not specifically described herein, as other parameters relating to the risk dimension may become apparent to those having skill in the art.

Core Factor (Risk Dimension). In even more particular aspects, a risk dimension map according to various embodiments including core factor, for example, can relate the core factor to a core parameter. The core parameter can indicate the importance of the business process with respect to business requirements.

Complexity Factor (Risk Dimension). Further, in even more particular aspects, a risk dimension map according to various embodiments including complexity factor, for example, can relate the complexity factor to a functional parameter. The functional parameter can indicate the dependence of the business process across multiple functions for its completion (i.e., service delivery). The complexity factor can also relate, for example, to a technological parameter. The technological parameter can measure the number of technologies involved in the completion of this process. The term technologies can also encompass platforms. The complexity factor can also relate, for example, to a geographical parameter. The geographical parameter can indicate the complexities of delivering services across multiple locations. The complexity factor can also relate, for example, to an operational parameter. The operational parameter can indicate the complication in managing the routine/day-to-day activities to complete the process. The complexity factor can also relate, for example, to a contractual parameter. The contractual parameter can measure the complexity arising out of having multiple contracts in completion of the process.

Criticality Factor (Risk Dimension). Further, in even more particular aspects, a risk dimension map according to various embodiments including criticality factor, for example, can relate the criticality factor to an impact parameter. The impact parameter can indicate the effect on the business if the process fails. The criticality factor can relate, for example, to a single-point-of-failure parameter. The single-point-of-failure parameter can indicate the effect on other business process if the process fails. The criticality factor can relate, for example, to a continuity parameter. The continuity parameter can indicate the level of availability required for the service by the business.

Volatility Factor (Risk Dimension). Further, in even more particular aspects, a risk dimension map according to various embodiments including volatility factor, for example, can relate the volatility factor to a volatility parameter. The volatility parameter can indicate instability of the process due to the inherent nature of the processes requirements.

Compliance-Risk Factor (Risk Dimension). Further, in even more particular aspects, a risk dimension map according to various embodiments including compliance-risk factor, for example, can relate the compliance-risk factor to a regulation/policy parameter. The regulation/policy parameter can indicate the degree to which adherence to organizational policies or government regulations are required for the completion of the process. The compliance-risk factor can also relate, for example, to a confidentiality parameter. The confidentiality parameter can indicate classification of information sensitivity based on organizational guidelines used in completing the process.

In more particular aspects, various embodiments herein can relate to a readiness dimension. As is described above, the readiness dimension can relate to a plurality of readiness factors, and one or more dimension maps may establish such relationships. In certain embodiments, for example, a readiness dimension map can relate one or more of the following readiness factors to the readiness dimension (520) as shown in FIG. 5b: an internal factor (521), a market factor (522), a stability factor (523), a maturity factor (524), and a documentation factor (525). Some embodiments may relate some but not all of these readiness factors to the readiness dimension, and other embodiments may relate to other readiness factors not specifically described herein, as other factors relating to the readiness dimension may become apparent to those having skill in the art. As is also described above, the readiness dimension and one or more readiness factors can relate to a plurality of readiness parameters, and one or more dimension maps may establish such relationships. In certain embodiments, for example, a readiness dimension map can relate one or more of the following readiness parameters to the readiness factors as is shown in FIG. 5b. Some embodiments may relate some but not all of the following readiness factors to the following readiness parameters, and other embodiments may relate to other readiness parameters not specifically described herein, as other parameters relating to the readiness dimension may become apparent to those having skill in the art.

Internal Factor (Readiness Dimension). In even more particular aspects, a readiness dimension map according to various embodiments including an internal factor (521), for example, can relate the internal factor to a technology parameter (5211). The technology parameter can indicate internal readiness (within a business) with respect to the technology components necessary for outsourcing the business process.

Market Factor (Readiness Dimension). Further, in even more particular aspects, a readiness dimension map according to various embodiments including a market factor, for example, can relate the market factor (522) to a technology parameter (5221). The technology parameter can indicate the external/market readiness with respect to the availability of the required technology in the completion of the business process. The market factor (522) can also relate, for example, to a skill parameter (5222). The skill parameter can indicate the availability of skill within local market for completion of the service.

Stability Factor (Readiness Dimension). Further, in even more particular aspects, a readiness dimension map according to various embodiments including a stability factor, for example, can relate the stability factor (523) to a consistency parameter (5231). The consistency parameter can indicate the constancy of service with respect to changes requested. (i.e., planned or unplanned).

Maturity Factor (Readiness Dimension). Further, in even more particular aspects, a readiness dimension map according to various embodiments including a maturity factor, for example, can relate the maturity factor (524) to a longevity parameter (5241). The longevity parameter can indicate the age of the business process from the time of its existence. The maturity factor (524) can also relate, for example, to a people parameter (5242). The people parameter can indicate the maturity of the organization involved in completion of the process.

Documentation Factor (Readiness Dimension). Further, in even more particular aspects, a readiness dimension map according to various embodiments including a documentation factor, for example, can relate the documentation factor (525) to a process parameter (5251). The process parameter can indicate the availability of documentation and degree of available documentation for the completion of the process. The documentation factor (525) can also relate, for example, to a policy parameter (5252). The policy parameter can indicate the availability of a formal policy requiring a document to be updated periodically.

In more particular aspects, various embodiments herein can relate to a return dimension. As is described above, the return dimension can relate to a plurality of return factors, and one or more dimension maps may establish such relationships. In certain embodiments, for example, a return dimension map can relate one or more of the following return factors to the return dimension as are shown in FIG. 5c: a business-specific factor (531), a cost-containment factor (532), a satisfaction factor (533), and an excellence factor (534). Some embodiments may relate some but not all of these return factors to the return dimension, and other embodiments may relate to other return factors not specifically described herein, as other factors relating to the return dimension may become apparent to those having skill in the art. As is also described above, the return dimension and one or more return factors can relate to a plurality of return parameters, and one or more dimension maps may establish such relationships. In certain embodiments, for example, a return dimension map can relate one or more of the following return factors to one or more of the following return parameters to the return factors as is shown in FIG. 5c. Some embodiments may relate some but not all of the following return factors to the following return parameters, and other embodiments may relate to other return parameters not specifically described herein, as other parameters relating to the return dimension may become apparent to those having skill in the art.

Business-Specific Factor (Return Dimension). In even more particular aspects, a return dimension map according to various embodiments including a business-specific factor, for example, can relate the business-specific factor (531) to a localization parameter (5311). The localization parameter can indicate the proportion of employees/contractors that are required to be sourced locally. The business-specific factor (531) can also relate, for example, to a resources-freed parameter (5312). The resources-freed parameter can indicate the number of employees that would be freed due to expected retirement or attrition. The business-specific factor (531) can also relate, for example, to a redeployment parameter (5313). The redeployment parameter can indicate the number of employees that could be redeployed (i.e., who are cross-skilled, cross-trained, or cross-certified).

Cost-Containment Factor (Return Dimension). Further, in even more particular aspects, a return dimension map according to various embodiments including a cost-containment factor, for example, can relate the cost-containment factor (532) to a competitive parameter (5321). The competitive parameter can indicate cost arbitrage by comparing current cost of completing the business process to the cost of similar service available in the market. The cost-containment factor (532) can also relate, for example, to a demand-variance parameter (5322). The demand-variance parameter can indicate variance in demand for this business process due to the inherent characteristics of the process. The cost-containment factor (532) can also relate, for example, to a retirement parameter (5323). The retirement parameter can indicate the remaining tenure of the service and value the cost advantage in outsourcing the same.

Satisfaction Factor (Return Dimension). Further, in even more particular aspects, a return dimension map according to various embodiments including a satisfaction factor, for example, can relate the satisfaction factor (533) to a satisfaction parameter (5331). The satisfaction parameter can indicate the current level of customer satisfaction and assess the existence of processes/procedures for collection and collation of customer feedback.

Excellence Factor (Return Dimension). Further, in even more particular aspects, a return dimension map according to various embodiments including an excellence factor, for example, can relate the excellence factor (534) to a performance parameter (5341). The performance parameter can indicate the existence or effectiveness of any defined measurements of process performance and the periodicity of capturing the measurement.

In more particular aspects, any of the dimension maps described herein can farther include one or more particular questions for each parameter, one or more particular responses for each question, and data tables or mathematical relationships to determine question scores or response scores based on responses to questions.

Databases may include the data itself, the structure or organization of the data, as well as the computer programs that define a set of operations that can be performed on the data. Databases can further include one or more computers dedicated to running such computer programs (i.e., a database server). Databases may include, for example, a database management system (“DBMS”) consisting of software that operates the database, supports query languages, provides storage, access, security, backup and other facilities. The DBMS may further include interface drivers, which are code libraries that provide methods to prepare statements, execute statements, and fetch results, for example. DBMS may further include a relational engine to implement relational objects such as Table, Index, and Referential integrity constraints. DBMS may further include a storage engine to store and retrieve data from secondary storage, as well as managing transaction commit and rollback and backup and recovery, for example. Data stored in the databases may be updated as needed, for example, by a user with administrative access to the database or to an area of the database, such as to add new data to tables or libraries in the database as they become supported.

It will be appreciated by those having skill in the art that data described herein as being stored in the databases may also be stored or maintained in non-transitory memory and accessed among two or more subroutines, functions, modules, objects, program products, or processes for example, according to objects or variables of such subroutines, functions, modules, objects, program products or processes. Any of the fields of the records, tables, libraries, and so on of the database may be flat files or multi-dimensional structures resembling an array or matrix and may include values or references to other fields, records, tables, or libraries. Any of the foregoing fields may contain actual values or a link, a join, a reference, or a pointer to other local or remote sources for such values. Further, any database may be, for example, a single database, multiple databases, or a virtual database, including data from multiple sources, for example, servers on the World Wide Web.

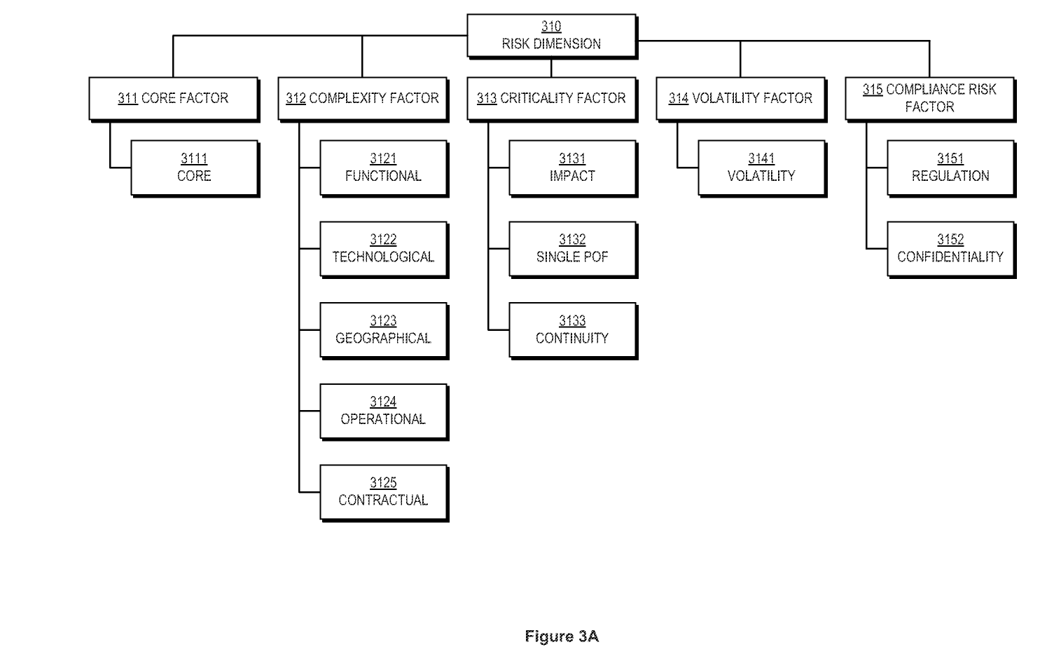

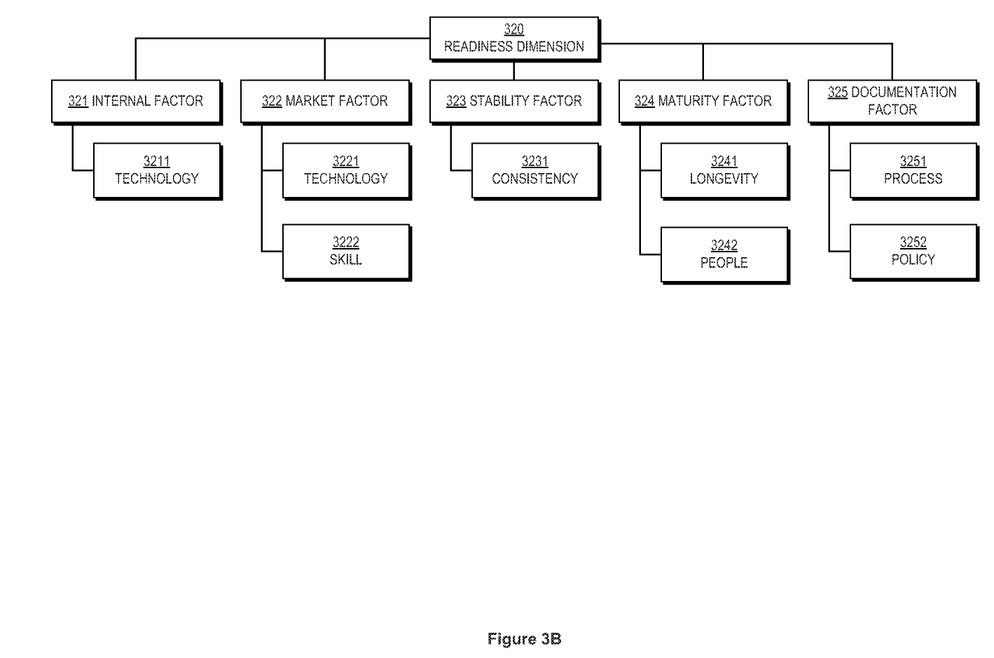

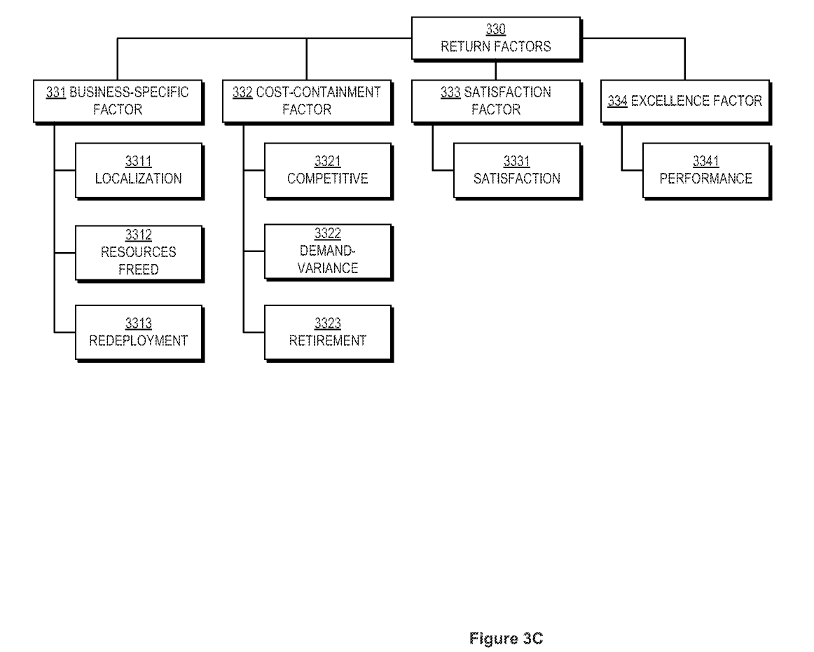

Functional aspects of various embodiments can be shown with reference to examples of systems including one or more modules, for example, such as application modules, computing devices, and data repositories. FIG. 3A depicts an example of a system (300) including one or more specially-configured modules to perform one or more specific functions described further herein. According to various embodiments, one or more of the modules described herein can communicate amongst each other such that each of the communicating modules can receive as input the output of another module.

According to various embodiments, the modules in the example system (300) described below can be implemented, for example, as specially-configured computing devices or as specially-configured software (e.g., application software) stored on a memory of a computing device to be executed by a processor of a computing device. In certain embodiments, each of the modules described below can be implemented as hardware, as software, or as a combination hardware and software. From the embodiments described herein it will be apparent to those having skill in the art that other embodiments are possible including any number of memories of any number of computer devices and operable on any number of processors, and all of such combinations are within the scope of this disclosure.

Additionally, one or more of the modules described below can communicate over a communications network (301), which can include, for example, one or more interconnected communications networks and can be implemented, for example, over various types of physical communication links and various layers of communications protocols. For instance, examples of communications networks (301) can local area networks (LANs), wide-area networks (WANs), virtual private networks (VPNs), telecommunications networks (e.g., GSM), and the Internet.

In various embodiments, one or more modules can include, for example, a questionnaire generator (320), a risk scorer (321), a readiness scorer (322), a return scorer (323), and a recommendation generator (324). In various embodiments, one or more of these modules can be in communication with a client device (310) for example, through the communications network (301). In various embodiments, one or more of these modules can be in communication with one or more data repositories, such as the dimension maps repository (391) or the factor weights repository (392) for example, through the communications network (301). The following paragraphs describe exemplary functions of, and interactions between, one or more of these modules with reference to any of FIG. 3A and FIG. 3B. Exemplary data flows are described further herein between and among one or more of these modules can be shown with reference to FIG. 3B.

A questionnaire generator (320), for example, can be configured to generate an outsourcing-questionnaire interface, for example, to be displayed at a display of a computing device such as the client device (310). In some embodiments, the questionnaire generator (320) can generate an outsourcing questionnaire interface responsive to one or more dimension maps, such as those stored in the dimension maps repository (391). Even further still, in certain embodiments, for example, the questionnaire generator (320) can apply computer implemented methods (or portions of computer implemented methods) as are described further herein.

A risk scorer (321), for example, can be configured to determine a risk score, for example, responsive to a plurality of user-selected risk responses, for example, as received from a computing device such as the client device (310) displaying the outsourcing-questionnaire interface. In some embodiments, the risk scorer (321) can determine a risk score further responsive to one or more dimension maps, such as those stored in the dimension maps repository (391), and one or more factor-weight profiles, such as those stored in the factor weight profile repository (392). Even further still, in certain embodiments, for example, the risk scorer (321) can apply computer implemented methods (or portions of computer implemented methods) as described further herein.

A readiness scorer (322), for example, can be configured to determine a readiness score, for example, responsive to a plurality of user-selected readiness responses, for example, as received from a computing device such as the client device (310) displaying the outsourcing-questionnaire interface. In some embodiments, the readiness scorer (322) can determine a readiness score further responsive to one or more dimension maps, such as those stored in the dimension maps repository (391), and one or more factor weight profiles, such as those stored in the factor weight profile repository (392). Even further still, in certain embodiments, for example, the readiness scorer (322) can apply computer implemented methods (or portions of computer implemented methods) as described further herein.

A return scorer (323), for example, can be configured to determine a return score, for example, responsive to a plurality of user-selected return responses, for example, as received from a computing device such as the client device (310) displaying the outsourcing-questionnaire interface. In some embodiments, the return scorer (323) can determine a return score further responsive to one or more dimension maps, such as those stored in the dimension maps repository (391), and one or more factor weight profiles, such as those stored in the factor weight profile repository (392). Even further still, in certain embodiments, for example, the return scorer (323) can apply computer implemented methods (or portions of computer implemented methods) as described further herein.

A recommendation generator (324), for example, can be configured to generate an outsourcing recommendation interface, for example, to be displayed at a display of a computing device, such as client device (310). In some embodiments, the recommendation generator (324) can generate an outsourcing recommendation interface responsive to each of the risk score, the readiness score, and the return score. Even further still, in certain embodiments, for example, the recommendation generator (324) can apply computer implemented methods (or portions of computer implemented methods) as described further herein.

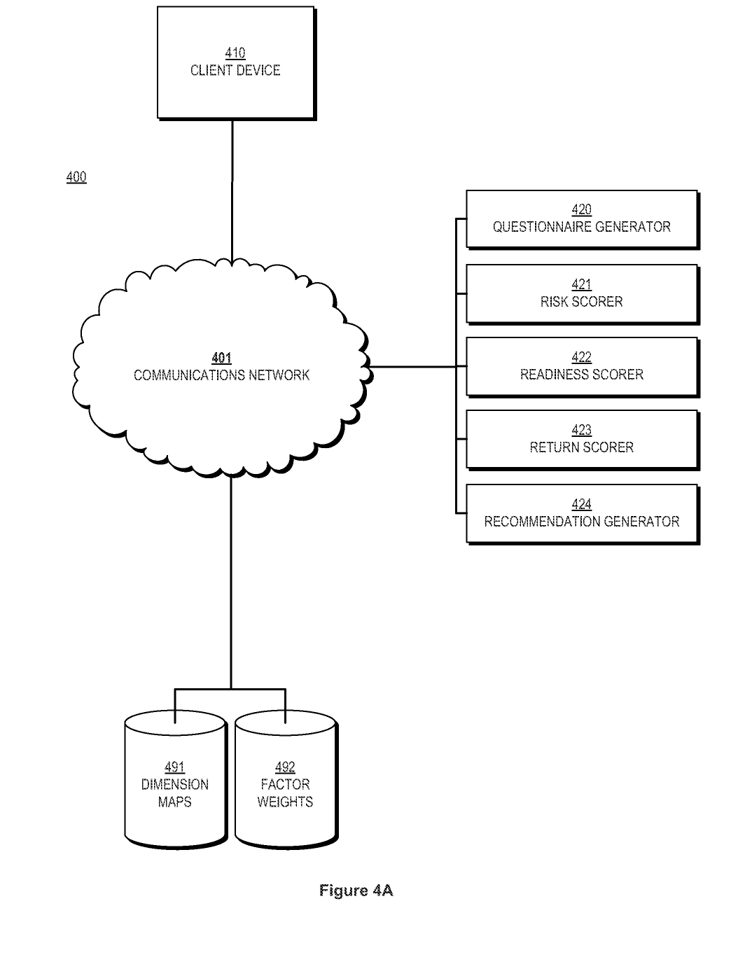

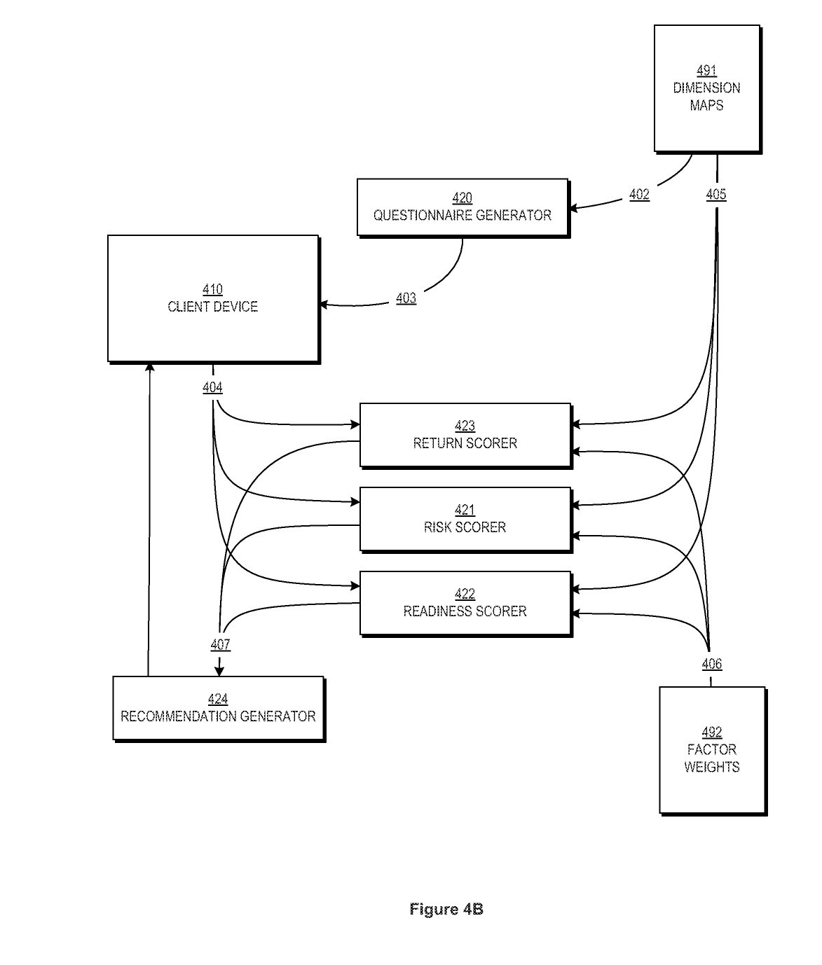

FIG. 4A depicts an embodiment of a system (400) including one or more client device (410) in communication with one or more server device (420), for example, through the communication network (401). In some embodiments, client device (410) may be configured as a client, and server device (420) as a server, in a client-server relationship. Other embodiments, however, may not adhere to a client-server model, and can be implemented according to various architectures or models. For example, one computing device or on multiple computing devices (e.g., according to a peer-to-peer model) can perform functions of either the client or the server device. The foregoing description of a “client” and a “server,” however, are not limiting, as a client device can be a “server” in some aspects, and a server device can be a “client” in some aspects, which will be understood by those having skill in the art in light of the embodiments disclosed.

In one example of embodiments, system (400) can include various computing devices such as a client device (410) and an outsourcing-evaluation server (420), each of which can be communicatively coupled through the communications network (401). In addition, each of the above-mentioned computing devices can be communicatively coupled, e.g., through the communications network (401), to one or more data repositories, one of which is illustrated as database (490). According to certain embodiments, database (490) can include, for example, any of the above-mentioned data repositories (391, 392).

A client device (410), for example, can provide a platform for one or more users to interact with the one or more user interfaces, for example, to display various user-interfaces to a user and also to receive selections by a user at one or more of the user-interfaces with respect to one or more business processes. In certain embodiments, the client device (410) can also provide a platform for interacting with one or more servers, such as an outsourcing evaluation server (420), for example, to receive various user-interfaces and also to transmit user-selections received at the user-interfaces. Also, either the client device (410) or the server device (420), according to various embodiments, for example, can provide a platform to determine one or more scores responsive to the user-selections and also to generate one or more user interfaces for display responsive to the determined scores.

According to certain embodiments, an example of a client device can be a computer, such as personal computer (e.g., laptop, desktop, tablet computer), as is illustrated in various drawings, including FIG. 1 and FIG. 2. In some embodiments, however, a client device may not be a personal computer but, instead, can be any type of computing device, including mobile devices that can be readily transported from one location to another location (e.g., smartphone, PDA, or cell phone). According to certain embodiments, an example of a server device can be an application server. In some embodiments, however, a server device may not specifically be an application server but, instead, can be any type of computing device to execute one or more processes upon request by another computing device, for another computing device, or to be output to another computing device, for example, a client device or another server device. Not all embodiments, however, determine scores, generate user interfaces, receive or transmit scores or interfaces, or allow one or more end users to interact with user interfaces, as the techniques described below have other applications, and other embodiments may offer other or different advantages, some of which are described below.

In various embodiments, a client device may be configured as shown with respect to client device (410) in FIG. 4. Client device (410) can include a processor (411), an input/output unit (“I/O”) (412) in communication with the processor, and a memory (413) in communication with the processor (411). According to some embodiments, client device (410) can further include other components as are described further herein.

Also, in various embodiments, a server device may be configured as shown with respect to outsourcing-evaluation server (420) in FIG. 4. Outsourcing-evaluation server can include a processor (421), an input/output unit (“I/O”) (422) in communication with the processor, and a memory (423) in communication with the processor (421). According to some embodiments, outsourcing-evaluation server (420) can further include other components as are described further herein.

In various embodiments, client device (410) and outsourcing-evaluation server (420) can be communicatively coupled through each of their respective input/output units (412, 422) to communicate over a communications network (401). In some embodiments, the client device (410) can communicate with other devices connected to the communication network (401) via a local area network (not pictured). For example, the I/O (412) at the client device (410) can include a network adapter to send and receive communications from and to local network devices (not shown) using various networking protocols and standards known to those having skill in the art, including those described further herein. Likewise, the outsourcing-evaluation server (420) can communicate with other devices connected to the communication network (401) via a local area network. For example, the I/O (422) at the outsourcing-evaluation server (420) can include a network adapter to send and receive communications from and to local network devices (not shown) using various networking protocols and standards known to those having skill in the art, including those described further herein.

FIG. 4 depicts that there can be stored on the client device (410), e.g., on the memory (413), one or more application modules (e.g., software modules), such as an interface display module (414). Any of the one or more application modules can be operable on the processor (411) to allow the client device to execute the one or more application modules. As will be appreciated by those having skill in the art, the memory (413) can also include an operating system or a set of programs to manage computer hardware resources and provide common services for application software. In certain embodiments, the interface display module (414) can include, for example, a web browser or other desktop software known to those having skill in the art (e.g., word processing software, spreadsheet/charting software, database software, slide presentation software, and flowcharting software). Also, in certain embodiments, the one or more application modules can include, for example, application software for interfacing with computer resources over the internet, such as a web-browser application, an email client application, an FTP client application, and applications that will be known to those having skill in the art. A web-browser application can, for example, when executed by the processor (411), receive information from one or more remote servers through the Internet, including information relating to an Internet-based interface, display an Internet-based interface to an end user of the client device (410) through one or more display (412A), receive user input through one or more user-input device (415B) with respect to the Internet-based interface, and transmit requests to one or more remote servers through the Internet, e.g., responsive to information received from the one or more remote servers.

FIG. 4 also depicts that there can be stored on the outsourcing-evaluation server (420), e.g., on the memory (423), one or more application modules. Each of the one or more application modules can be operable on the processor (421) to allow the outsourcing-evaluation server (420) to execute the one or more application modules (429). As will be appreciated by those having skill in the art, the memory (423) can also include an operating system or a set of programs to manage computer hardware resources and provide common services for application software. In certain embodiments, the one or more application modules (429) can include, for example, any of the questionnaire generator (320), risk scorer (321), readiness scorer (322), return scorer (323), and recommendation generator (324).

As will be apparent to those having skill in the art, some of the above-mentioned application modules may also be stored on other computing devices, including devices not described herein that are remotely accessible to the device through communication network (401), such as devices in “the cloud.” For example, as is shown in FIG. 4b, any of the questionnaire generator (320), risk scorer (321), readiness scorer (322), return scorer (323), and recommendation generator (324) can be stored on the memory (413) of the client device (410) and executed by the processor (411) of the client device (410). Likewise, any of the application modules can be positioned in communication with and among each other according to various APIs (application programming interfaces), standards, or protocols. Further, in some embodiments, one or more application modules stored on one computing device may be remotely accessible to another computing device as a client in a client-server architecture, for example, through the communication network (401). According to various embodiments, any of the application modules stored on one device can be executed by one or more processors of that respective device or by one or more processors of different devices. Also, according to various embodiments, user interfaces can be generated by application modules executing on one or more processors of one device and displayed at a display of that device or at one or more displays of different devices. Those having skill in the art will appreciate that other embodiments in which processing and displaying are divided between different devices, and such embodiments are within the scope of this disclosure.

As will be understood with reference to the following paragraphs and the referenced drawings, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such computer-readable storage media with regard to embodiments of computer-implemented methods described. Likewise, any reference to the following computer-implemented methods with respect to systems and computer-readable storage media is provided for explanatory purposes, and is not intended to limit any of such computer-implemented methods described.

FIG. 6 illustrates exemplary embodiments of a computer-implemented method (600) to provide one or more graphical outsourcing recommendations for a business process responsive to user-selections relating to the business process. Graphical outsourcing recommendations according to the computer-implemented method (600) can be provided to a user of a computing device at a user interface, for example, displayed at a display of the computing device. User-selections relating to the business process according to the computer-implemented method (600) can be received at a user interface, for example, displayed at the display of the computing device.

Embodiments of computer-implemented methods (600) can include generating (601) an outsourcing-questionnaire interface to be displayed at a display (103) of a computing device such that the user (102) can interact with the outsourcing-questionnaire interface. In some embodiments, for example, the step of generating (601) the outsourcing-questionnaire interface can be performed by the questionnaire generator module (320), which can be implemented, for example, on software executed by the outsourcing evaluation server (420). In certain embodiments, generating (601) the outsourcing-questionnaire interface can be performed responsive to a plurality of risk questions, a plurality of readiness questions, and a plurality of return questions, for example, stored in the dimension maps (600A). Generating (601) the outsourcing-questionnaire interface can include, in some embodiments, generating a plurality of risk response fields corresponding to the plurality of risk questions, a plurality of readiness response fields corresponding to the plurality of readiness questions, and a plurality of return response fields corresponding to the plurality of return questions.

Embodiments of computer-implemented methods (602) can also include receiving (602) a plurality of user-selected responses from a computing device. For example, the user can selected the user-selected responses at the outsourcing-questionnaire interface displayed at the display of the computing device. The plurality of user-selected responses can include, for example, one or more user-selected risk responses, one or more user-selected readiness responses, and one or more user-selected return responses. In some embodiments, for example, receiving (602) the plurality of user-selected responses can be performed, respectively, by the risk scorer module (321), the readiness scorer module (322), or the return scorer module (323), which can be implemented, for example, on software executed by the outsourcing evaluation server (420).

Embodiments of computer-implemented methods (600) can further include determining (603) a plurality of parameter scores responsive to user-selected responses. In some embodiments, for example, the plurality of parameter scores can include a plurality of risk-parameter scores, a plurality of readiness-parameter scores, or a plurality of return-parameter scores. In certain embodiments, determining (603) a plurality of parameter scores can be performed responsive to the plurality of user-selected risk responses received at a respective risk response field, a plurality of user-selected readiness responses received at a respective readiness response field, and a plurality of user-selected return responses received at a respective return response field. In more particular aspects, determining (603) a plurality of parameter scores can be performed responsive to response scores for the user-selected responses as described above. In certain embodiments, determining (603) a plurality of parameter scores can be performed responsive to a plurality of dimension maps (600A), for example a risk map, a readiness map, and a return map, each of which can provide mathematical relations between response scores (e.g., for the foregoing user-selected responses) and parameter scores. In some embodiments, for example, determining (603) a plurality of parameter scores can be performed, respectively, by the risk scorer module (321), the readiness scorer module (322), or the return scorer module (323), each which can be implemented, for example, on software executed by the outsourcing evaluation server (420). In more particular aspects, determining (603) a risk-parameter score can include averaging a response score for each of the plurality of user-selected risk responses that correspond to the respective risk parameter. Also, in more particular aspects, determining (603) a readiness-parameter score can include averaging a response score for each of the plurality of user-selected readiness responses that correspond to the respective readiness parameter. Also, in more particular aspects, determining (603) a return-parameter score can include averaging a response score for each of the plurality of user-selected return responses that correspond to the respective return parameter.

Embodiments of computer-implemented methods (600) can even further include determining (604) a plurality of factor scores responsive to user-selected responses. The plurality of factor scores can include, for example, a plurality of risk-factor scores, a plurality of readiness-factor scores, and a plurality of return-factor scores. In certain embodiments, determining (604) a plurality of factor scores can be performed responsive to the plurality of user-selected risk responses received at a respective risk response field, a plurality of user-selected readiness responses received at a respective readiness response field, and a plurality of user-selected return responses received at a respective return response field. In more particular aspects, determining (604) a plurality of factor scores can be performed responsive to determining (603) a plurality of parameter scores as described above. In certain embodiments, determining (604) a plurality of factor scores can be performed responsive to a plurality of dimension maps (600A), for example a risk map, a readiness map, and a return map, each of which can provide mathematical relations between response scores (e.g., for the foregoing user-selected responses), parameter scores, and factor scores. In some embodiments, for example, determining (604) a plurality of factor scores can be performed, respectively, by the risk scorer module (321), the readiness scorer module (322), or the return scorer module (323), which can be implemented, for example, on software executed by the outsourcing evaluation server (420). In more particular aspects, determining (604) a risk-factor score for a risk-factor can include averaging a plurality of risk-parameter scores, each of the plurality of risk-parameter scores being for a respective risk parameter relating to the risk factor. Also, in more particular aspects, determining (604) a readiness-factor score for a readiness-factor can include averaging a plurality of readiness-parameter scores, each of the plurality of readiness-parameter scores being for a respective readiness parameter relating to the readiness factor. Also, in more particular aspects, determining (604) a return-factor score for a return-factor can include averaging a plurality of return-parameter scores, each of the plurality of return-parameter scores being for a respective return parameter relating to the return factor.

Embodiments of computer-implemented methods (600) can also include determining (605) a plurality of dimension scores responsive to user-selected responses. The plurality of dimension scores can include, for example, each of a risk score, a readiness score, and a return score. In certain embodiments, determining (605) a plurality of dimension scores can be performed responsive to the plurality of user-selected risk responses received at a respective risk response field, a plurality of user-selected readiness responses received at a respective readiness response field, and a plurality of user-selected return responses received at a respective return response field. In more particular aspects, determining (605) a plurality of dimension scores can be performed responsive to determining (603) a plurality of parameter scores and determining (604) a plurality of factor scores as described above. In certain embodiments, determining (605) a plurality of dimension scores can be performed responsive to a plurality of dimension maps (600A), for example a risk map, a readiness map, and a return map, each of which relate response scores (e.g., for the foregoing user-selected responses) to parameter scores, factor scores, and dimension scores. In some embodiments, for example, determining (605) a plurality of dimension scores can be performed by each of a risk scorer (321), a readiness scorer (322), and a return scorer (323), which can be implemented, for example, on software executed by the outsourcing evaluation server (420). In more particular aspects, determining (604) a risk score can include averaging a plurality of risk-factor scores, each of the plurality of risk-factor scores being for a respective risk factor relating to the risk dimension. Also, in more particular aspects, determining (604) a readiness score can include averaging a plurality of readiness-factor scores, each of the plurality of readiness-factor scores being for a respective readiness factor relating to the readiness dimension. Also, in more particular aspects, determining (604) a return score can include averaging a plurality of return-factor scores, each of the plurality of return-factor scores being for a respective return factor relating to the return dimension. In even further embodiments, any of the foregoing averages can be a weighted average, for example, performed responsive to one or more factor-weighting profiles (600B), for example a risk-factor weighting profile, a readiness-factor weighting profile, and a return-factor weighting profile. Any of the one or more factor-weighting profiles can be pre-selected or user-selected according to various embodiments. User-selected factor-weighting profiles, for example, can allow a user to refine the process of determining a dimension score to reflect a certain strategic alignment of the different factors of the dimension.

Embodiments of computer-implemented methods (600) can further include generating (606) an outsourcing-recommendation interface to be displayed at a display of a computing device such that the user (102) can interact with the outsourcing-recommendation interface and, perhaps, make an outsourcing decision (608) based on recommendations displayed at the outsourcing recommendation interface. In some embodiments, for example, generating (606) an outsourcing-recommendation interface can be performed by the recommendation generator module (324), which can be implemented, for example, on software running on the outsourcing-recommendation server (420). In certain embodiments, generating (606) an outsourcing-recommendation interface can be performed responsive to the plurality of dimension scores. In certain embodiments, the plurality of dimension scores can include for example, each of a risk score, a readiness score, and a return score. Also, for example, generating (606) an outsourcing-recommendation interface can be performed responsive to determining (605) each of the risk score, readiness score, and return score as described above.

In more particular aspects, the outsourcing recommendation interface can be a graphical chart having a coordinate space defined by a first axis and a second axis. For instance, an example of a graphical chart can include four recommendation quadrants in the coordinate space, and each of these four recommendation quadrants can correspond to a different outsourcing recommendation. Also, for instance, an example of a graphical chart can include a “process-recommendation bubble” (corresponding to a business process) that is displayed at a determined position in the coordinate space. The determined position can correspond to each of the risk score and the readiness score, for example, for the respective business process. Also, for instance, the process-recommendation bubble can have a surface area of a determined size in the coordinate space. The determined size can correspond to the return score, for example, for the respective business process. An intersection between the process-recommendation bubble and one or more of the four recommendation quadrants can provide a graphical recommendation to a user, when viewing the display, concerning the suitability of outsourcing the respective business process. For example, the graphical recommendation can be the outsourcing recommendation corresponding to the recommendation quadrants intersected.

Certain embodiments of computer-implemented methods (600) can further still include receiving (607A) one or more new user-selected responses, including for example one or more new user-selected risk responses, one or more new user-selected readiness responses, and one or more new user-selected return responses, from the outsourcing-questionnaire interface displayed at a display of a computing device. According to certain embodiments, the user can select the one or more new user-selected responses after having viewed the outsourcing-recommendation interface displayed at the display of a computing device. For example, the user may wish to change one or more of the original user-selected responses based on the outsourcing-recommendation interface displayed at the display of the computing device. In certain embodiments, receiving (607A) one or more new user-selected responses can be performed as described with respect to receiving (602) the plurality of user-selected responses (the “initial plurality of user-selected responses”).

Certain embodiments of computer-implemented methods (600) can further still include receiving (607B) a new user-selected factor-weighting profile, including for example one or more user-selected risk-factor-weighting profile, one or more user-selected readiness-factor-weighting profile, and one or more user-selected return-factor-weighting profile. According to certain embodiments, the user can select the one or more new user-selected factor-profiles after having viewed the outsourcing-recommendation interface displayed at the display of a computing device. For example, the user may wish to change the operable factor-weighting profile based on the outsourcing-recommendation interface displayed at the display of the computing device.

In certain embodiments, responsive to receiving (607A) one or more new user-selected responses or responsive to receiving (607B) a new user-selected factor-weighting profile, the steps of determining (603) a plurality of parameter scores, determining (604) a plurality of factor scores, determining (605) a plurality of dimension scores, and generating (606) an outsourcing-recommendation interface can be re-performed responsive to one or more new user-selected responses or to one or more new user-selected factor-weighting profiles. For example, a new plurality of parameter scores, a new plurality of factor scores, and a new plurality of dimension scores can be determined responsive to the new user-selected responses. Also, for example, a new plurality of dimension scores can be determined responsive to the new user-selected factor-weighting profiles. Also, for example, the graphical chart can include new process-recommendation bubble being displayed at a position in the coordinate space corresponding to each of a new risk score and a new readiness score and having a surface area corresponding to a new return score. Also, a new process-recommendation bubble can intersect one or more of the four recommendation quadrants to provide a new graphical recommendation to a user, when viewing the display. For example, the new graphical recommendation can correspond to the recommendation quadrants intersected by the new process-recommendation bubble. In certain embodiments, for example, the new process-recommendation bubble can replace the original process-recommendation bubble. In other embodiments, for example, the new process-recommendation bubble can be displayed at the same time as the initial process-recommendation bubble.

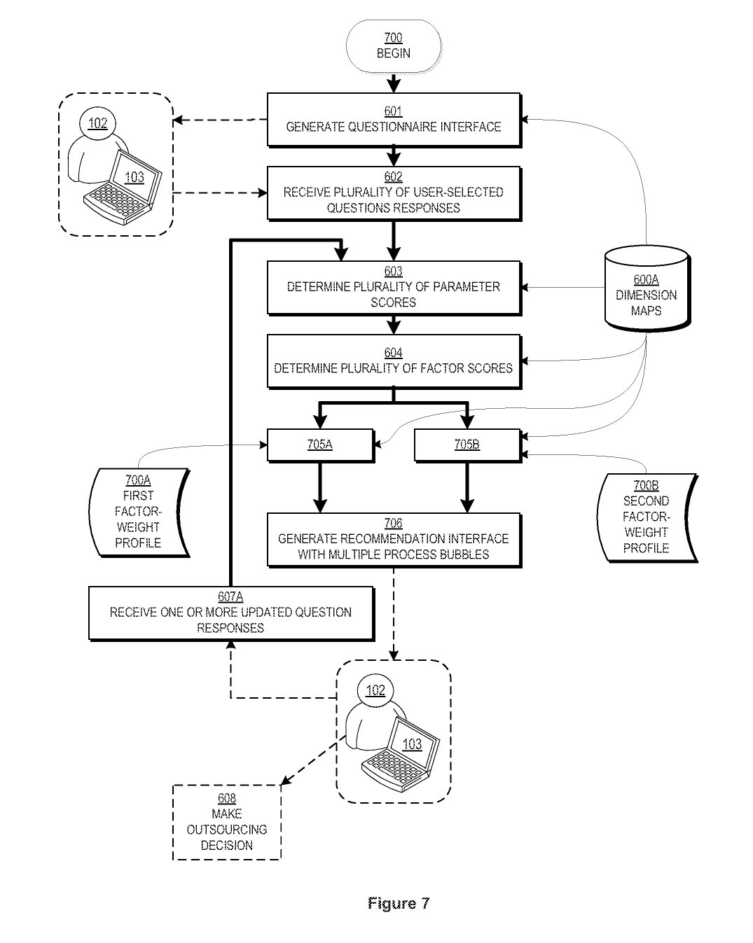

FIG. 7 illustrates exemplary embodiments of a computer-implemented method (700) that can provide a plurality of graphical outsourcing recommendations with respect to a business process. According to certain embodiments, the computer-implemented method (700) builds on aspects of the computer-implemented method (600) illustrated in FIG. 6 and can further include generating (706) an outsourcing-recommendation interface including multiple process-recommendation bubbles to be displayed at a display of a computing device such that the user (102) can interact with the outsourcing-recommendation interface and, perhaps, make an outsourcing decision (608) based on the outsourcing recommendation interface.

For example, embodiments of the computer-implemented method (700) can include any of the steps (601), (602), (603), (604) and (607A), which are described above with respect to computer-implemented method (600). Also, according to certain embodiments, the computer-implemented method (700) extending aspects of the computer-implemented method (600), for example, can include performing any step (605) multiple times, for example, responsive to different factor-weight profiles. In more particular aspects, the computer-implemented method (700) can include determining (705A) a first plurality of dimension scores, such as a first risk score, first readiness score, and first return score, responsive to a first factor-weight profile (700A) and determining (705B) a second plurality of dimension scores, such as a second risk score, second readiness score, and second return score, responsive to a second factor-weight profile (700B). Different factor-weighting profiles, for example, can allow parallel determination of different sets of dimension scores to reflect a different strategic alignment of the factors for any dimension.

In more particular aspects, generating (706) an outsourcing-recommendation interface including a plurality of process-recommendation bubbles can be performed by the recommendation generator module (324), which can be implemented, for example, on software running on the outsourcing-recommendation server (420). In certain embodiments, generating (706) an outsourcing-recommendation interface including a plurality of process-recommendation bubbles can be performed responsive to a first plurality of dimension scores including, for example, each of a first risk score, a first readiness score, and a first return score and to a second plurality of dimension scores including, for example, each of a second risk score, a second readiness score, and a second return score. For example, generating (706) an outsourcing-recommendation interface can be performed responsive to determining (705A) each of the first risk score, first readiness score, and first return score and determining (705B) each of the second risk score, second readiness score, and second return score.

As is described with respect to FIG. 6, the outsourcing recommendation interface can be a graphical chart having a coordinate space defined by a first axis and a second axis. For instance, an example of a graphical chart can include four recommendation quadrants in the coordinate space, and each of the four recommendation quadrants can correspond to a different outsourcing recommendation. According to certain embodiments, the graphical chart can include a plurality of process-recommendation bubbles being displayed at a different positions and having a different size in the coordinate space, with each different process-recommendation bubble corresponding to a different set of dimension scores (e.g., a respective risk score and readiness score and having a surface area corresponding to a respective return score). For example, a first process-recommendation bubble can correspond to a first risk score and a first readiness score and have a surface area corresponding to a first return score. Also, for example, a second process-recommendation bubble can correspond to a second risk score and a second readiness score and have a surface area corresponding to a second return score. Also, the plurality of process-recommendation bubbles can intersect one or more of the four recommendation quadrants to provide different graphical recommendations to a user, when viewing the display. For example, each of the plurality of graphical recommendations can correspond to the recommendation quadrants intersected by a different process-recommendation bubble. The different process-recommendation bubbles, therefore, can provide parallel recommendations for the same business process that reflect different strategic alignments of the factors for any dimension.

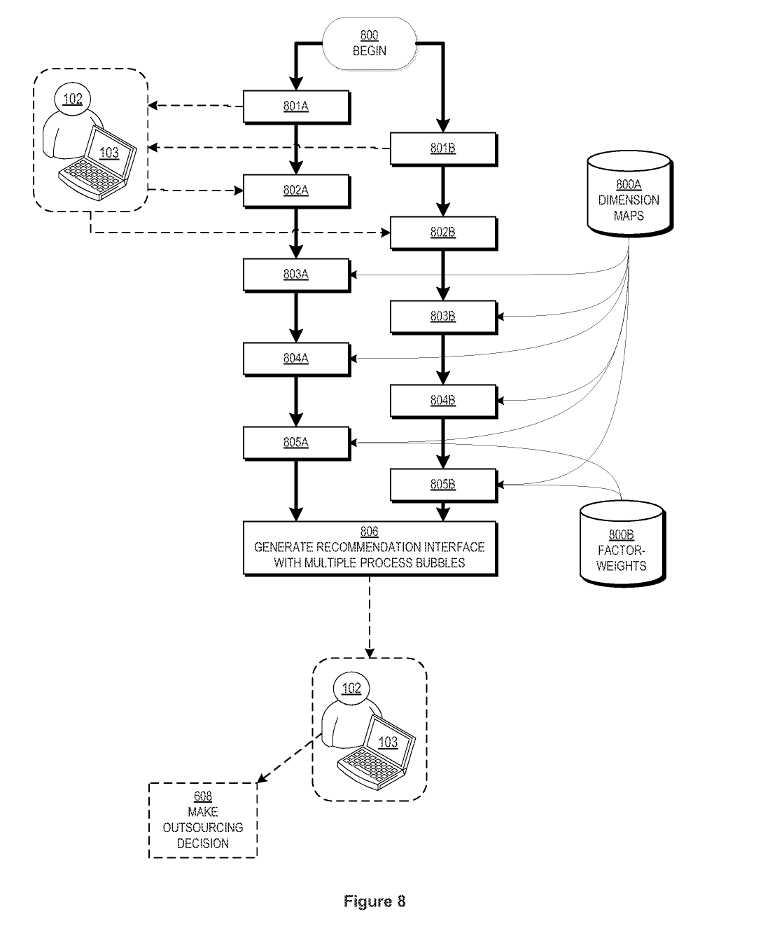

FIG. 8 also illustrates exemplary embodiments of a computer-implemented method (800) that can provide one or more graphical outsourcing recommendations with respect to a plurality of business processes. According to certain embodiments, the computer-implemented method (800) builds on aspects of the computer-implemented method (600) illustrated in FIG. 6 and can further include generating (806) an outsourcing-recommendation interface including a plurality of process-recommendation bubbles to be displayed at a display of a computing device, such that the user (102) can interact with the outsourcing-recommendation interface and, perhaps, make an outsourcing decision (807) based on the outsourcing recommendation interface. The plurality of process-recommendation bubbles can be provided, for example, with respect to each of a plurality of business processes (e.g., a first business process and a second business process).

In more particular aspects, the computer-implemented method (800) can include generating (801A) a first outsourcing-questionnaire interface and generating (801B) a second outsourcing-questionnaire interface, both to be displayed at a display of a computing device such that the user (102) can interact with the outsourcing-questionnaire interfaces. More particular aspects of generating (801A, 801B) an outsourcing-questionnaire interface are described with respect to step (601) of the computer-implemented method (600) with reference to FIG. 6. In certain embodiments, for example, the second outsourcing-questionnaire interface can be a copy of the first outsourcing-questionnaire interface.

Also, in more particular aspects, computer-implemented method (800) can include receiving (802A) a first plurality of user-selected responses and receiving (802B) a second plurality of user-selected responses. The first plurality of user-selected responses can include, for example, one or more user-selected risk responses, one or more user-selected readiness responses, and one or more user-selected return responses, from the first outsourcing-questionnaire interface displayed at a display of a computing device. The second plurality of user-selected responses can include, for example, one or more user-selected risk responses, one or more user-selected readiness responses, and one or more user-selected return responses, from the second outsourcing-questionnaire interface displayed at a display of a computing device. More particular aspects of receiving (802A, 802B) user-selected responses are described with respect to step (602) of the computer-implemented method (600) and with reference to FIG. 6.

Also, in more particular aspects, computer-implemented method (800) can include determining (803A) a first plurality of parameter scores including, for example, a first plurality of risk-parameter scores, a first plurality of readiness-parameter scores, and a first plurality of return-parameter scores, as well as determining (803B) a second plurality of parameter scores including, for example, a second plurality of risk-parameter scores, a second plurality of readiness-parameter scores, and a second plurality of return-parameter scores. Determining (803A, 803B) one or more parameter scores can be performed responsive to one or more dimension maps, for example, which can be stored in the dimension map repository (800A). More particular aspects of determining (803A, 803B) a first plurality of parameter scores and a second plurality of parameter scores are described with respect to step (603) of the computer-implemented method (600) and with reference to FIG. 6.

Also, in more particular aspects, computer-implemented method (800) can include determining (804A) a first plurality of factor scores including, for example, a first plurality of risk-factor scores, a first plurality of readiness-factor scores, and a first plurality of return-factor scores as well as determining (804B) a second plurality of factor scores including, for example, a second plurality of risk-factor scores, a second plurality of readiness-factor scores, and a second plurality of return-factor scores. Determining (804A, 804B) one or more factor scores can be performed responsive to one or more parameter scores and one or more dimension maps, for example, which can be stored in the dimension map repository (800A). More particular aspects of determining (804A, 804B) a first plurality of factor scores and a second plurality of factor scores are described with respect to step (604) of the computer-implemented method (600) and with reference to FIG. 6.

Also, in more particular aspects, computer-implemented method (800) can include determining (805A) a first plurality of dimension scores including, for example, each of a first risk score, a first readiness score, and a first return score as well as determining (805B) a second plurality of dimension scores including, for example, each of a second risk score, a second readiness score, and a second return score. More particular aspects of determining (805A, 805B) a first plurality of dimension scores and a second plurality of dimension scores are described with respect to step (605) of the computer-implemented method (600) and with reference to FIG. 6.

In addition, determining (805A) a first plurality of risk scores can be performed responsive to a first plurality of risk-factor scores, the first risk map, and a first risk-factor weighting-profile; a first plurality of readiness scores can be performed responsive to a first plurality of readiness-factor scores, the first readiness map, and a first readiness-factor weighting-profile; and a first plurality of return scores can be performed responsive to a first plurality of return-factor scores, the first return map, and a first return-factor weighting-profile. Likewise, determining (805B) a second plurality of risk scores can be performed responsive to a second plurality of risk-factor scores, the second risk map, and a second risk-factor weighting-profile; a second plurality of readiness scores can be performed responsive to a second plurality of readiness-factor scores, the second readiness map, and a second readiness-factor weighting-profile; and a second plurality of return scores can be performed responsive to a second plurality of return-factor scores, the second return map, and a second return-factor weighting-profile. Likewise,

Also, in more particular aspects, computer-implemented method (800) can include generating (806) an outsourcing-recommendation interface including multiple process-recommendation bubbles. More particular aspects of generating (806) an outsourcing-recommendation interface are described with respect to step (606) of the computer-implemented method (600) and with reference to FIG. 6. In certain embodiments, generating (806) an outsourcing-recommendation interface including multiple process-recommendation bubbles can be performed responsive to the first plurality of dimension scores including, for example, each of a first risk score, a first readiness score, and a first return score and to the second plurality of dimension scores including, for example, each of a second risk score, a second readiness score, and a second return score. For example, generating (806) an outsourcing-recommendation interface can be performed responsive to determining (805A) each of the first risk score, first readiness score, and first return score and determining (805B) each of the second risk score, second readiness score, and second return score.

As is described with respect to FIG. 8, the outsourcing recommendation interface can be a graphical chart having a coordinate space defined by a first axis and a second. For instance, an example of a graphical chart can include four recommendation quadrants in the coordinate space, and each of the four recommendation quadrants can correspond to a different outsourcing recommendation. According to certain embodiments, the graphical chart can include a plurality of process-recommendation bubbles being displayed at a different positions in the coordinate space, with each different process-recommendation bubble corresponding to a respective risk score and readiness score and having a surface area corresponding to a respective return score. For example, a first process-recommendation bubble can correspond to a first risk score and a first readiness score and have a surface area corresponding to a first return score. Also, for example, a second process-recommendation bubble can correspond to a second risk score and a second readiness score and have a surface area corresponding to a second return score. Also, the plurality of process-recommendation bubbles can intersect one or more of the four recommendation quadrants to provide different graphical recommendations to a user, when viewing the display. For example, each of the plurality of graphical recommendations can correspond to the recommendation quadrants intersected by a different process-recommendation bubble. The different process-recommendation bubbles, therefore, can provide parallel recommendations for different business processes so that the relative suitability of outsourcing different business processes can be directly compared.

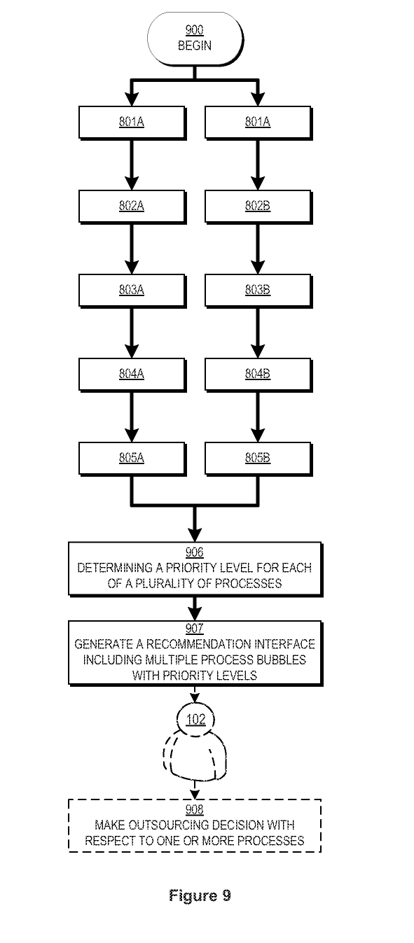

FIG. 9 also illustrates exemplary embodiments of a computer-implemented method (900) that can provide one or more priority levels with respect to a plurality of business processes. According to certain embodiments, the computer-implemented method (900) builds on aspects of the computer-implemented method (800) illustrated in FIG. 8 and can further include determining (906) a priority level for each business process of the plurality of business processes, as well as generating (907) an outsourcing-recommendation interface including multiple process-recommendation bubbles with priority levels to be displayed at a display of a computing device such that the user (102) can interact with the outsourcing-recommendation interface and, perhaps, make an outsourcing decision (908) based on the outsourcing recommendation interface. The multiple bubble regions can be provided, for example, with respect to each of a first business process and a second business process. In other embodiments, however, additional bubble regions can be provided, for example, with respect to additional business processes in the same manner as described with respect to steps (801B-805B).

In certain embodiments, determining (906) a priority level for each business process of the plurality of business processes can be performed responsive to a plurality of dimensions for each of the business processes. A first-level priority (“Priority I”) can be determined, for example, responsive to a low risk score, a high readiness score, and high return score for a certain business process. A second-level priority (“Priority II”) can be determined, for example, responsive to a low risk score, a low readiness score, and high return score; or low risk score, high readiness score, and low return score for a certain business process. A third-level priority (“Priority III”) can be determined, for example, responsive to a high risk score, high readiness score, and high return score for a certain business process. A fourth-level priority (“Priority IV”) can be determined, for example, responsive to a low risk score, low readiness score, and low return score for a certain business process. Furthermore, in certain embodiments, generating (907) an outsourcing recommendation interface including a plurality of process bubbles can include, for example, displaying a determined priority level in conjunction with a process-recommendation bubble for a respective business process. The display of recommendations in conjunction with prioritization advantageously allows business-process owners to consider recommendations in conjunction with a corresponding timeframe for outsourcing activities. For example, Priority I business processes can relate to a near-term initiative (e.g., 1-18 months), Priority II business processes can relate to a medium-term initiative (e.g., 18-36 months); and Priority III and IV business processes can relate to a long-term initiative (e.g., 18-36 months).

Various embodiments may further include non-transitory computer-readable storage medium having stored thereon a set of executable instructions that, when executed by the one or more processors, causes one or more devices or systems to perform various operations as are described in further detail herein.

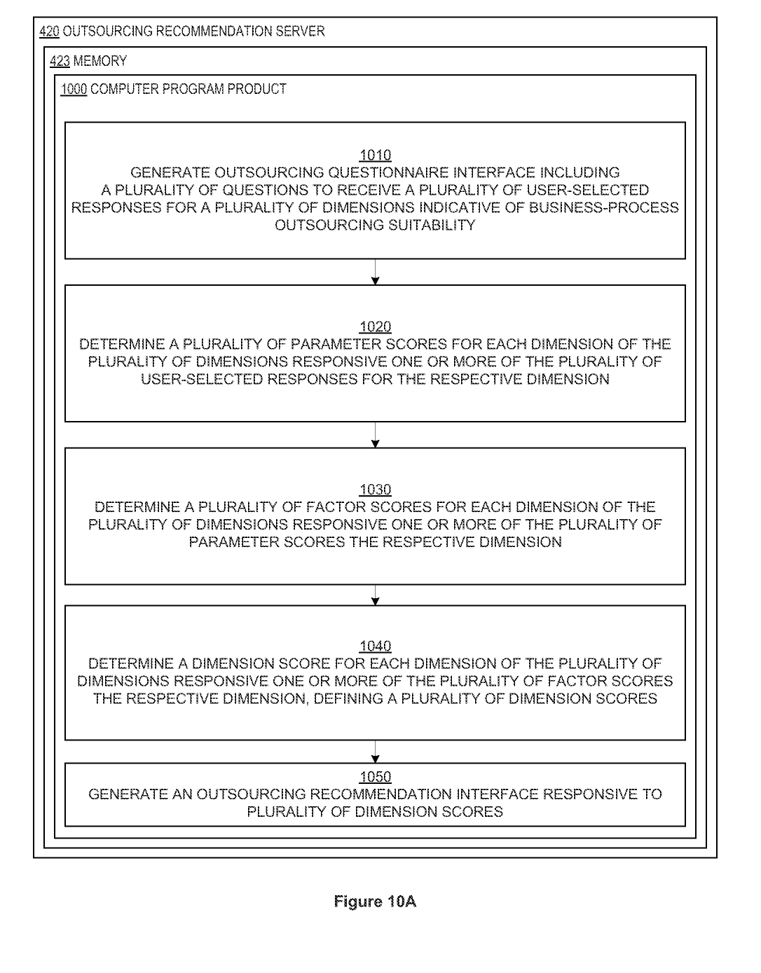

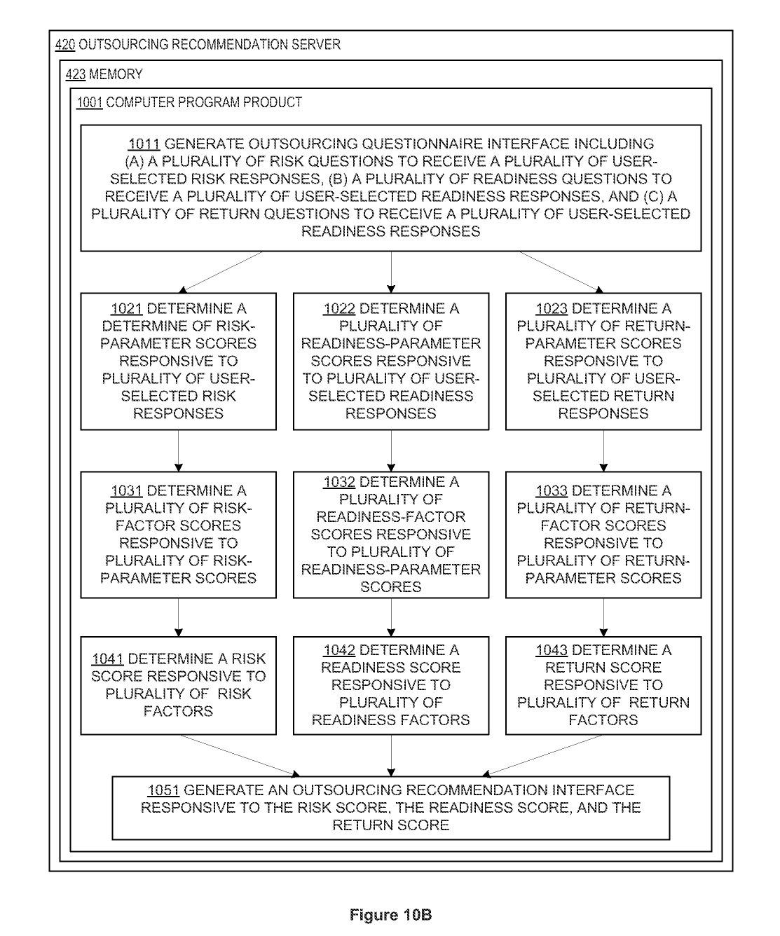

FIG. 10A illustrates an example of a set of instructions in a computer program product (1000) stored on a non-transitory computer-readable storage medium, such as the memory (423) and operable on a processor (not shown) of a computer device, such as the processor (421) of the outsourcing recommendation server (420). Such examples are provided for exemplary purposes only, and the illustrated set of instructions and the computer program product (1000) are not intended to being implemented on the outsourcing recommendation server (420). For example, such a computer program product (1000), or other computer program products, may be implemented on one or more devices, including the devices illustrated in FIG. 4, for example.

In some embodiments, for example, a computer program product (1000), for example, may include an instruction that, when executed, causes one or more devices to (1010) generate an outsourcing questionnaire interface including a plurality of questions to receive a plurality of user-selected responses for a plurality of dimensions indicative of business-process outsourcing suitability.

Also, in some embodiments, for example, a computer program product (1000), for example, may include an instruction that, when executed, causes one or more devices to (1020) generate a plurality of parameter scores for each dimension of the plurality of dimensions responsive one or more of the plurality of user-selected responses for the respective dimension.

Further, in some embodiments, for example, a computer program product (1000), for example, may include an instruction that, when executed, causes one or more devices to (1030) generate a plurality of factor scores for each dimension of the plurality of dimensions responsive one or more of the plurality of parameter scores the respective dimension.

Even further, in some embodiments, for example, a computer program product (1000), for example, may include an instruction that, when executed, causes one or more devices to (1040) Generate A dimension score for each dimension of the plurality of dimensions responsive one or more of the plurality of factor scores the respective dimension, defining a plurality of dimension scores.

Further still, in some embodiments, for example, a computer program product (1000), for example, may include an instruction that, when executed, causes one or more devices to (1050) Generate an outsourcing recommendation interface responsive to plurality of dimension scores.

FIG. 10B illustrates an example of a set of instructions in a computer program product (1001) stored on a non-transitory computer-readable storage medium, such as the memory (423) and operable on a processor (not shown) of a computer device, such as the processor (421) of the outsourcing recommendation server (420). Such examples are provided for exemplary purposes only, and the illustrated set of instructions and the computer program product (1001) are not intended to being implemented on the outsourcing recommendation server (420). For example, such a computer program product (1001), or other computer program products, may be implemented on one or more devices, including the devices illustrated in FIG. 4, for example.

In some embodiments, for example, a computer program product (1001), for example, may include an instruction that, when executed, causes one or more devices to (1011) Generate outsourcing questionnaire interface including (a) a plurality of risk questions to receive a plurality of user-selected risk responses, (b) a plurality of readiness questions to receive a plurality of user-selected readiness responses, and (c) a plurality of return questions to receive a plurality of user-selected readiness responses.

Also, in some embodiments, for example, a computer program product (1001), for example, may include an instruction that, when executed, causes one or more devices to (1021) generate a plurality of risk-parameter scores responsive to plurality of user-selected risk responses. Also, in some embodiments, for example, a computer program product (1001), for example, may include an instruction that, when executed, causes one or more devices to (1022) generate a plurality of readiness-parameter scores responsive to plurality of user-selected readiness responses. Also, in some embodiments, for example, a computer program product (1001), for example, may include an instruction that, when executed, causes one or more devices to (1023) generate a plurality of return-parameter scores responsive to plurality of user-selected return responses.

Further, in some embodiments, for example, a computer program product (1001), for example, may include an instruction that, when executed, causes one or more devices to (1031) generate a plurality of risk-parameter scores responsive to plurality of user-selected risk responses. Further, in some embodiments, for example, a computer program product (1001), for example, may include an instruction that, when executed, causes one or more devices to (1032) generate a plurality of readiness-parameter scores responsive to plurality of user-selected readiness responses. Further, in some embodiments, for example, a computer program product (1001), for example, may include an instruction that, when executed, causes one or more devices to (1033) generate a plurality of return-parameter scores responsive to plurality of user-selected return responses.

Even further, in some embodiments, for example, a computer program product (1001), for example, may include an instruction that, when executed, causes one or more devices to (1041) generate a risk score responsive to plurality of risk factors. Even further, in some embodiments, for example, a computer program product (1001), for example, may include an instruction that, when executed, causes one or more devices to (1042) generate a readiness score responsive to plurality of readiness factors. Even further, in some embodiments, for example, a computer program product (1001), for example, may include an instruction that, when executed, causes one or more devices to (1043) generate a return score responsive to plurality of return factors.

Further still, in some embodiments, for example, a computer program product (1001), for example, may include an instruction that, when executed, causes one or more devices to (1051) generate an outsourcing recommendation interface responsive to the risk score, the readiness score, and the return score.

A description of various user interfaces according to various embodiments of the subject invention follows with reference to FIGS. 12, 13, and 14. Various user-interfaces described herein are operable to interface with a user of a device displaying the interface, such as user (102) as illustrated in FIGS. 1A, 1B, and 1C, for example. As described herein, a user of a device can be defined with reference to the name of the device. For example, a user of a “client device” can be referred to as a client-device user. Any type of user mentioned, described, or implied herein can simply be referred to as a “user,” and the absence of any more descriptive modifier should not be interpreted to create ambiguity. For example, a “user” interacting with a client device is intended to be the same as a “client-device user.” Furthermore, the term “user” as an adjective can be used to describe or define an aspect relating to the user itself, the device used by the user, or both the user and the device used by the user. For example, a “user account” can be an account linked to the user (e.g., according to a username and password known to the user), an account linked to a device (e.g., according to a unique device identifier), or can be both (e.g., according to a username and password stored in the device and/or a device identifier known to the user, such as a telephone number). As will be understood by those having skill in the art, there may be more than one device associated with any one user, and there may be more than one user associated with any one device. Accordingly, the use of “user” in the singular is not intended to imply that there cannot be more than one user of the same device, unless specifically stated otherwise.

The user interfaces described herein present information to a user of the equipment (e.g., a device having a display, or a separate display device) on which the user-interface is displayed. The information presented to a user through the interface may be presented in specifically-configured display fields that present the information in a specific manner, including, for example, the position of the information as displayed, the orientation of the information as displayed, the content of the information displayed, the relation between the position or orientation of the information as displayed and other information as displayed, the relation between the position or orientation of the information and displayed and various types of user-selection fields as described further herein, and the relation between the content of the information displayed and various types of user-selection fields as described further herein. Other manners of presenting information in the display of a user-interface may be described herein or may be apparent to those having skill in the art based on the description of various embodiments herein.

In some embodiments, the user-interfaces described herein also allow a user of the equipment on which the user-interface is displayed to make selections (“user-selections”) with respect to the information presented in the display of the user interface using a user-input interface as described further herein. The user-selections can be made in specifically-configured selection fields that collect information, for example, to be submitted (e.g., transmitted) to various types of computer processes. Various types of display fields can also be user-selection fields, and vice-versa. User-selection fields can include, for example, text input boxes, radio selection buttons, checkboxes, hyperlinks, image-map or region-map, hyperlinks, selection boxes, selection lists, or submit buttons. A plurality of user-selection fields may also be referred to as a single user-selection field according to various embodiments, for example, when multiple selections are interrelated. A submit button is a type of user-selection field that allows the user to make a selection to submit information existing in one or more user-selection fields to a computer process.

Not all user-selection fields require that a user make a selection of one option exclusively, and some user-selection fields may present a user with only one option. Not all selection fields require that a user take affirmative action to make a selection (e.g., a selection field may be pre-selected or a form having multiple selection fields may programmatically submit responsive to user-selections). Not all selection fields require that a user directly enter the same information that constitutes the user-selection (e.g., a user can “mouse over” a region of an image corresponding to certain image coordinates, and the user's selection can be a variable that corresponds to those certain image coordinates).

Those having skill in the art will appreciate various techniques for constructing various types of user interfaces including, for example, one or more graphical layers, one or more layers of selection fields, client-side scripting to programmatically make user-selections responsive to user actions (e.g., mouse-overs via a mouse, hand gestures via a touch-screen, audible commands via a microphone and speech recognition software, etc.)

With reference to FIG. 113B, an exemplary computing device, more particularly a personal computer (101) is shown. It should be noted that the personal computer (101) is illustrated for exemplary purposes only and that the following user interfaces being displayed on any other computing device is within the scope of this disclosure. In further detail with respect to the personal computer (101), it can be shown that the personal computer (101) includes a housing (101A) to enclose and protect the contents of the personal computer (101), which can include any of the components described of any mobile device herein, including those illustrated in FIGS. 4A and 4B with respect to client device (410), for example. The personal computer (101) further includes a display, such as LCD (“Liquid Crystal Display”) (103), which is visible to a user (102), for example, when the user uses the personal computer (101). The personal computer (101) further includes a user input interface, such as the keyboard (106), which is accessible to the user (102), for example, when the user uses the personal computer (101). The illustration of FIG. 1B, however, is merely exemplary and not all embodiments are limited to the use of a keyboard. For example, a mouse (not shown) and a touch screen sensor (not shown) can also be used, as well as other user-input interfaces known to those having skill in the art. Likewise, not all embodiments are limited to the use of an LCD as the display, and other displays will be known to those having skill in the art.

An example of an outsourcing questionnaire interface is depicted in FIG. 11. Outsourcing questionnaire interface (1100), for example, may include a plurality of question fields. Each of the plurality of question fields can relate to a dimension of a plurality of dimensions. One question field, i.e., risk question field (1110), for example, may relate to a risk dimension. Another question field, i.e., readiness question field (1120), for example, may relate to a readiness dimension. Yet another question field, i.e., return question field (1130), for example, may relate to a return dimension.

Each question field may include, for example, a plurality of questions and a plurality of corresponding selection fields for users to select responses to questions. For example, one question (1111) includes text for a first risk question and can correspond to a selection field (1111A) for a user to select a response with respect to the first risk question. As is shown in FIG. 12, other questions (1112, 1113) and corresponding selection fields (1112A, 1113A) can be included in the risk question field. Likewise, questions (1121, 1122, 1123) and corresponding selection fields (1121A, 1122A, 1123A) can be included in the readiness question field. And likewise, questions (1131, 1132, 1133) and corresponding selection fields (1131A, 1132A, 1133A) can be included in the return question field. Each of the questions and their corresponding selection fields can correspond to different factors for each of the respective dimensions. Although not depicted, each of the questions can be labeled or grouped and labeled as a group based on the corresponding factor.

The outsourcing questionnaire interface (1120) can include various types of response fields according to various types of questions. Examples of response fields that are drop-down selection boxes can be shown for response fields (1111A, 1121A, 1131A, 1112A, 1122A). Also, examples of response fields that are selection boxes can be shown for response fields (1113A, 1123A). In some embodiments, the values shown in the response fields can be, for example, the score itself, as is shown for some response fields (1112A, 1122A, 1133A). Other examples of response fields are slider fields (1133A) and text input fields (1132A). In some embodiments, the values shown in the response fields can be a text value that corresponds to a score, as is shown for other response fields (1111A, 1121A, 1131A, 1123A). For example, a text value of “High” can correspond to a score value of 5, a text value of “Moderate” can correspond to a score value of 3, and a text value of “Low” can correspond to a value of 1. In various embodiments, different text values can correspond to different score values. For example, different text values such as “Never,” “Always,” and “Sometimes” can correspond to different scores, as is shown for response field (1121A, 1113A).

Although the outsourcing questionnaire interface (1100) shows a plurality of response fields and a plurality of selection fields being displayed simultaneously, not all response fields and not all question fields must be displayed simultaneously. Also, not all selection fields and response fields for different dimensions must be displayed simultaneously. For example, questions and corresponding response fields can be displayed sequentially as if turning the page between questions or can be scrolled through vertically as if navigating a webpage. The layout provided by outsourcing questionnaire interface (1100) is intended only to show a correlation between questions, response fields, and dimensions (e.g., selection fields), and it is not essential that the display of questions and corresponding response fields be grouped by dimension (e.g., in a single selection field). Likewise, it is not essential that the display of questions and corresponding response fields be grouped according to the same factor.

An example of an outsourcing recommendation interface is depicted in FIG. 12. Outsourcing recommendation interface (1200), for example, may include a multidimensional chart having an x-axis and a v-axis, such as the risk-readiness-return chart (1200A). The multidimensional chart (1200A), for example, includes a process-recommendation bubble (1201) positioned along the y-axis according to a first dimension, e.g., risk score (1200Y) and positioned along the x-axis according to a second dimension, e.g., readiness score (1200X). The size of the process-recommendation bubble (1201) reflects a third dimension, e.g., return score (1200Z). Further, the x-y coordinate space of the chart (1200A) can be divided into quadrants, each of which can correspond to an outsourcing recommendation concerning the scored business process. For example, a first quadrant (1210) corresponds to a recommendation to retain (1211) the business process, a second quadrant (1220) corresponds to a recommendation to go slow (1221) in considering the business process for future outsourcing, a third quadrant (1230) corresponds to a recommendation to consider (1231) the business process for outsourcing, and a fourth quadrant (1240) corresponds to a recommendation to improve (1241) the process for outsourcing. The visual display of the process-recommendation bubble (1201) positioned solely in the second quadrant (1220) provides an unambiguous recommendation to “go slow” (1221).

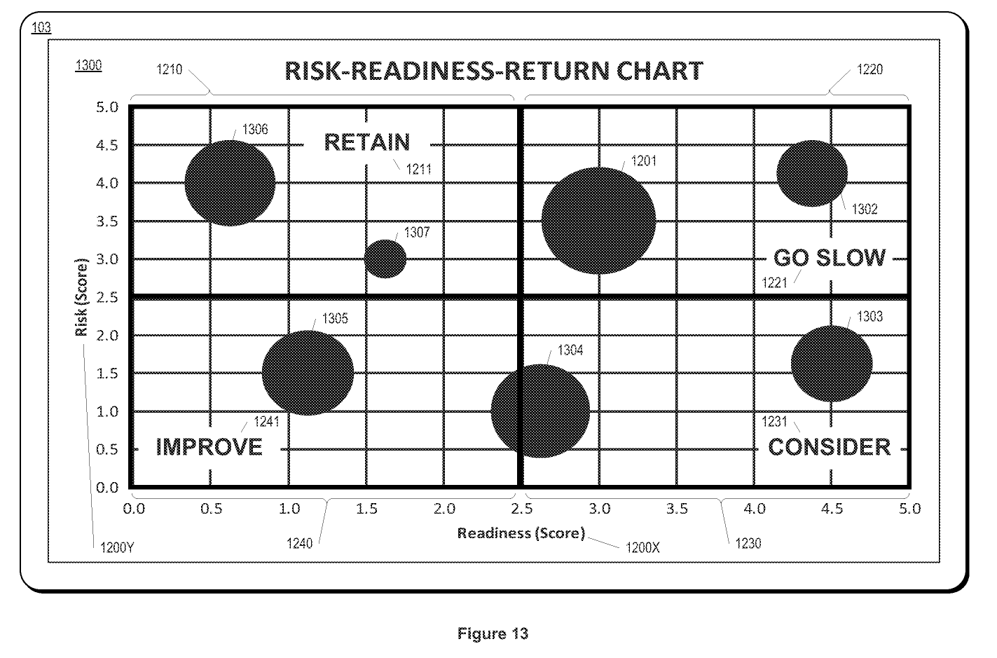

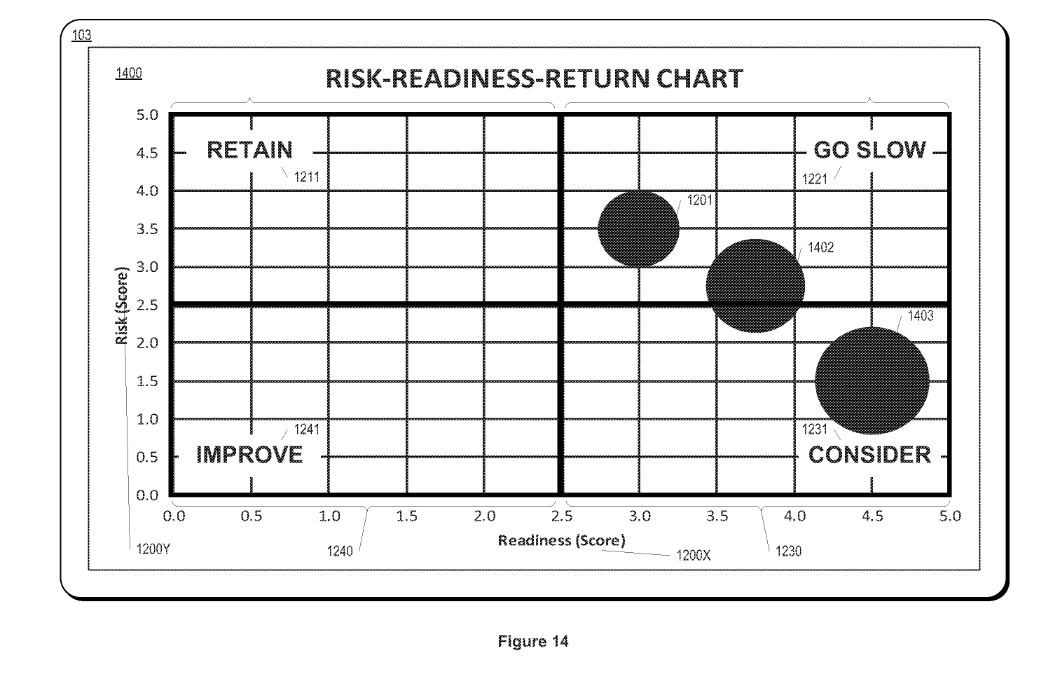

Another example of an outsourcing recommendation interface (1300) is depicted in FIG. 13. Many of the numbered features identified in FIG. 13 are also present in FIG. 14, and in addition, FIG. 14 shows a plurality of process-recommendation bubbles (1201, 1302, 1303, 1304, 1305, 1306, 1307). The multiple process-recommendation bubbles, for example, can be generated responsive to different sets of dimension scores, e.g., for different user selections for different processes or for different user selections for the same process. The visual display of the multiple process-recommendation bubbles, e.g., positioned in different quadrants, provides multiple recommendations to the user contemporaneously, based on different inputs. For example, if the multiple process-recommendation bubbles correspond to different processes, the user can readily compare the recommendations for the different processes, e.g., to prioritize outsourcing decisions. The strength of the recommendations, for example, may be observed by the relative positions of the multiple process-recommendation bubble in the respective quadrant, e.g., along the x-axis and the y-axis. Also, for example, the user can readily compare the return value (e.g., potential payoff) corresponding to the different processes, e.g., to prioritize outsourcing decisions, by comparing the size of the multiple process-recommendation bubbles.

For example, a user may readily compare a first process-recommendation bubble (1303) to a second process-recommendation bubble (1304), both of which correspond the “consider” recommendation (1231), as they are centered in the third quadrant (1230). The relative position of first process-recommendation bubble (1303) compared to the second process-recommendation bubble (1304), suggests that the first process has a greater degree of readiness and a greater degree of risk than the second process. Accordingly, a user may determine that the outsourcing of the first process is prioritized over that of the second process. The relative size of first process-recommendation bubble (1303) compared to the second process-recommendation bubble (1304), however, suggests that the first process has a lower degree of return than the second process. Accordingly, a user may reconsider the prioritization of outsourcing the first and second process on this basis.

Also, for example, a user may readily compare a third process-recommendation bubble (1306) to a fourth process-recommendation bubble (1307), both of which correspond the “retain” recommendation (1211), as they are centered in the first quadrant (1210). The relative position of fourth process-recommendation bubble (1303) compared to the third process-recommendation bubble (1304), suggests that the fourth process has a greater degree of readiness and a lesser degree of risk than the third process. Accordingly, user may determine that the fourth process may be more likely to evolve over time to be a process that will be considered for outsourcing. The relative size of fourth process-recommendation bubble (1303) compared to the third process-recommendation bubble (1304), however, indicates that the fourth process has a lower degree of return than the third process, should either process be selected for outsourcing.

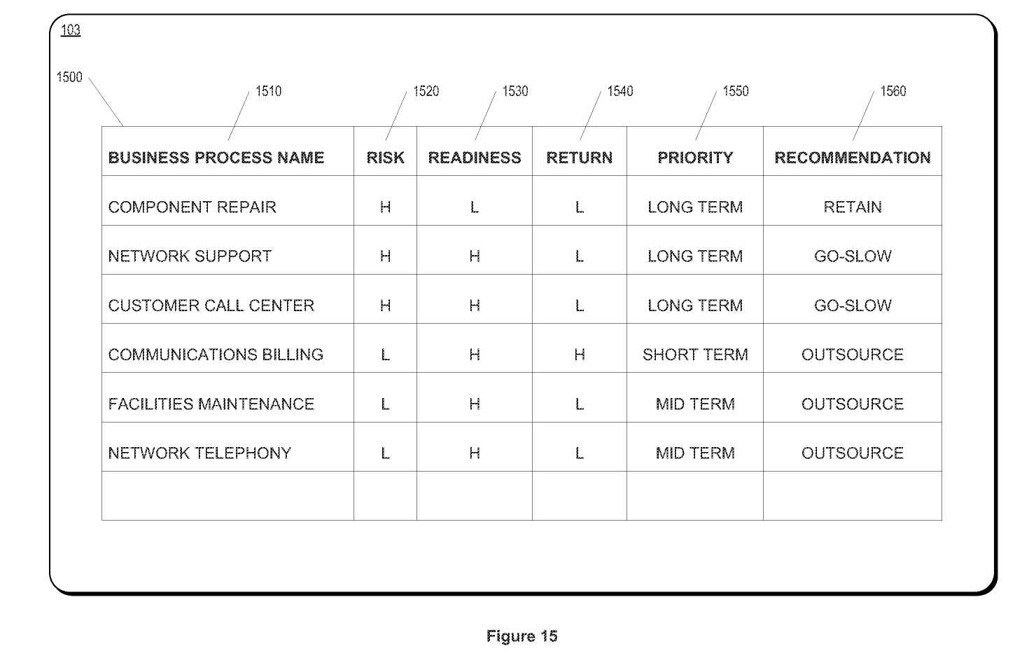

Another example of an outsourcing recommendation interface (1400) is depicted in FIG. 14. Many of the numbered features identified in FIG. 13 are also present in FIG. 15, and in addition, FIG. 15 shows multiple process-recommendation bubbles (1201, 1402, 1403). The multiple process-recommendation bubbles, for example, can be generated responsive to different factor-weighting profiles, e.g., conservative, moderate, aggressive. The visual display of the multiple process-recommendation bubbles, e.g., positioned in different quadrants, provides multiple recommendations to the user contemporaneously, based on different inputs. For example, the user can readily compare the effects of different strategic objectives (e.g., reflected in the different weighting-profiles) on the recommendation offered, e.g., to value or substantiate different strategic outlooks. The effects of different strategic objectives on risk and readiness, for example, may be observed by the relative position of the process-recommendation bubble in the respective quadrant, e.g., along the x-axis and the y-axis. Also, for example, the user can readily compare the return value (e.g., potential payoff) corresponding to the strategic outlooks by comparing the size of the multiple process-recommendation bubbles.

Accordingly, both the outsourcing questionnaire interface and the outsourcing recommendation interface operate in conjunction to display to the user the relation between different circumstances (e.g., as indicated in the questions, responses, parameters, factors, and dimensions) that affect the desirability of outsourcing business processes. Further, the systematic implementation of modular evaluation modules and strategic objectives (e.g., according to different dimension maps and factor weighting profiles) to drive both the outsourcing questionnaire interface and the outsourcing recommendation interface advantageously provides a consistent and repeatable basis (e.g., for various processes, for one process at various times, or for one process according to different strategic objectives) for users to receive recommendations for evaluating and selecting business processes for outsourcing.

In certain embodiments, for example, a data table interface can be generated for a plurality of business process responsive to any of their respective dimension scores, priority levels, or recommendations as described herein. For example, FIG. 15 shows a data table interface (1500) including a plurality of business processes names in the business process column (1510), a plurality of respective risk scores in a risk column (1520), a plurality of respective readiness scores in a readiness column (1530), a plurality of respective return scores in a return column (1540), a plurality of priority levels in a priority column (1550), and a plurality of respective recommendations in a recommendation column (1560). Presentation of the foregoing data advantageously allows users to sort or to rank any of the data therein to compare the relative suitability of any of the plurality of business processes for outsourcing, based on a plurality of parameters.

Any device described herein, such as the client device (410) or the outsourcing recommendation sever (420) may be computing devices according to various embodiments, as either a client, as a server, a plurality of clients, or a plurality of servers. Computing devices are intended to represent various forms of digital computers, such as laptops, desktops, workstations, personal digital assistants, servers, blade servers, mainframes, and other appropriate computers. For example, the client device (410) can be a mobile computing device, such as personal digital assistant, cellular telephone, smartphone, and other similar computing device. For any of the computing devices described herein, any of the processors, memories, I/O units, interfaces, displays, peripherals, adapters, or components, (“components”) described herein can be interconnected using various busses, and may be mounted on a common motherboard or in other manners as appropriate. The components described and/or shown herein, their connections and relationships, and their functions, are intended to be exemplary only.

Various implementations of the systems and techniques described here can be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to other devices or systems, including components of the same device or system such as an input device or an output device.

Computer programs (also known as programs, software, software applications, code, or application modules) include machine instructions for a programmable processor, and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Any of the processors can also include separate analog and digital processors. In other implementations, multiple processors and/or multiple buses may be used as part of any one processor, as appropriate, along with multiple memories and types of memory. Also, multiple computing devices may be connected, with each device providing portions of the necessary operations (e.g., as a server bank, a group of blade servers, or a multi-processor system). Any of the processors can provide, for example, for coordination of the other components of a computing device, such as control of user interfaces, applications run by the computing device, and wireless communication by a computing device.

To provide for interaction with a user, the systems and techniques described here may be implemented on a computer having a display device (a “display”) such as a CRT (cathode ray tube) or LCD (liquid crystal display) monitor to display information to the user, an input device (a “user-input device”) such as a keyboard or a pointing device (e.g., touch-screen sensor, a mouse, or a trackball) by which the user can provide input to the computer, or combinations of display devices and input devices such as a display overlaid on a user-input device (e.g., a touch-screen device). Other categories of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input. In certain embodiments, the display can be, for example, a TFT-LCD, an OLED, or other appropriate display technology known to those having skill in the art. The display can include appropriate circuitry for driving the display to present graphical and other visual information to a user. The user-input device can receive commands from a user and convert them for submission to the processor and can be any type of device configured or adapted for such purpose, including, for example a keyboard, keypad, touch-screen sensor, microphone, camera, pointer, trackball, trackpad, and other devices known to those having skill in the art.

In certain embodiments, any of the processors described herein can process instructions for execution within the respective computing device, including instructions stored in the memory or on the storage device to display graphical or visual information for a graphical user interface (“GUI”) on an display device in a manner that the user can also input information, through the user-input device for example, with respect to the graphical or visual information displayed on the GUI.

Embodiments may be implemented, e.g., at least in part, in hardware or software or combinations of hardware software. Hardware may include, for example, analog, digital or mixed-signal circuitry, including discrete components, integrated circuits (ICs), or application-specific ICs (ASICs). Embodiments may also be implemented, in whole or in part, in software or firmware, which may cooperate with hardware. Processors for executing instructions may retrieve instructions from a data storage medium, such as EPROM, EEPROM, NVRAM, ROM, RAM, a CD-ROM, a I-DD, and the like. Computer program products may include storage media that contain program instructions for implementing embodiments described herein.

Any of the memories described herein can store data such that the data can be said to be stored in a respective computing device including a respective memory. In certain implementations however, any the computing devices described herein can access remote memories included in other computing devices, as will be appreciated by those having skill in the art. In various implementations, a memory may be a computer-readable medium, a volatile memory unit or units, or a non-volatile memory unit or units. A storage device may be capable of providing mass storage for a computing device. In one implementation, the storage device can be a computer-readable medium. In various different implementations, the storage device can be a floppy disk device, a hard disk device, an optical disk device, or a tape device, a flash memory or other similar solid-state memory device, or an array of devices, including devices in a storage area network or other configurations. In one implementation, a computer program product is tangibly embodied in an information carrier. The computer program product contains instructions that, when executed, perform one or more processes, such as the computer-implemented methods described above. The information carrier can be a computer- or machine-readable medium, such as a memory, a storage device, a memory on processor, or a propagated signal.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet. The computing system can include clients and servers. A client and server are generally remote from each other and typically interact through a communication network. The relationship of client and server arises by virtue of computer programs running on the respective computers and having a client-server relationship to each other.

Any of the I/O units described herein can include, for example, a high-speed controller, a low-speed controller, or both a high-speed controller and a low-speed controller. A high-speed controller can manage bandwidth-intensive operations for the computing device, and the low speed controller can manages lower-bandwidth-intensive operations. Such an allocation of duties is exemplary only. In one implementation, an I/O unit can be coupled to a memory, a display (e.g., through a graphics processor or accelerator), and to one or more expansion ports, such as a high-speed expansion port or a low-speed expansion port, each of which may accept various expansion cards (not shown). Any of the I/O units can include various communication ports (e.g., Universal Serial Bus (“USB”), Bluetooth, Ethernet, wireless Ethernet), may be coupled to one or more input devices or output devices, (either of which can also be an input/output device), such as a keyboard, a pointing device, a scanner, or a networking device such as a switch or router, e.g., through a network adapter. An input/output unit can include, for example, a wireless communication interface, and a computing device may communicate wirelessly through the wireless communication interface, which may include digital signal processing circuitry where necessary.

A number of implementations have been described. Nevertheless, it will be understood that various modifications may be made without departing from the spirit and scope of this disclosure. Accordingly, other implementations are within the scope of the claims. Various embodiments may further include receiving, sending or storing instructions and/or data implemented in accordance with the foregoing description upon a computer-accessible medium. Generally speaking, a computer-accessible/readable storage medium may include non-transitory storage media, such as magnetic or optical media, (e.g., disk or DVD/CD-ROM); volatile or non-volatile media, such as RAM (e.g., SDRAM, DDR, RDRAM, SRAM, etc.) or ROM, for example.

Certain embodiments may be implemented, for example, on a computing device, such as a personal computer, and various aspects described herein, such as modules, data repositories, dimension maps, and dimension profiles, for example, can be implemented within one or more commercially-available applications executed on the computing device. For example, various aspects described herein can be implemented on a personal computer executing applications provided by Microsoft Corporation of Redmnond, Wash., such as Microsoft Excel and Microsoft Access. Also, for example, various aspects described herein can be implemented on a personal computer executing other commercially-available spreadsheet applications featuring data storage, calculation, graphing tools, pivot tables, and macro-programming capabilities, for example.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be used independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms of articles, such as “a”, “an” and “the,” include plural referents unless the content clearly indicates otherwise. Thus, for example, reference to “an element” includes a combination of two or more elements, and features attributed to that element may be features of each of the two or more elements or different elements of the two or more elements may each have different, potentially overlapping, subsets of the attributed features. Words related to numbering used herein—such as “primary,” “secondary,” “first,” “secondary,” “first,” “second,” “third” or other ordinal numbers—are merely descriptive and do not define or connote any specific order or degree of importance except as expressly qualified herein. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic, optical, or magnetic quantities within memories, registers, or other information storage devices, transmission devices, or display devices of the special purpose computer or similar special purpose electronic processing/computing device.

That claimed is:

1. A computer-implemented method to provide one or more graphical outsourcing recommendations for a business process to a user of a computing device having a display, the computer-implemented method comprising the steps of:
a. generating an outsourcing questionnaire interface, to be displayed at a display of a computing device, the outsourcing questionnaire interface including a plurality of risk questions and a corresponding plurality of risk response-fields, a plurality of readiness questions and a corresponding plurality of readiness response-fields, and a plurality of return questions and a corresponding plurality of return response-fields;
b. determining a risk score, a readiness score, and a return score for a business process responsive to a plurality of user-selected risk responses relating to the business process received at the plurality of risk response-fields, a plurality of user-selected readiness responses relating to the business process received at the plurality of readiness response-fields, and a plurality of user-selected return responses relating to the business process received at the plurality of return response-fields; and
c. generating an outsourcing recommendation interface, to be displayed at a display of a computing device, responsive to determining each of the risk score, the readiness score, and the return score for the business process, the outsourcing recommendation interface being a graphical chart having a coordinate space defined by a first axis and a second axis, the graphical chart comprising:
i. four recommendation quadrants of the coordinate space, each of the four recommendation quadrants being indicative of a corresponding outsourcing recommendation, and
ii. a process-recommendation bubble for the business process being displayed at a position in the coordinate space responsive to each of the risk score and the readiness score and having a surface area responsive to the return score, the process-recommendation bubble intersecting one or more of the four recommendation quadrants to provide a graphical outsourcing recommendation for the business process to a user, when viewing the display, corresponding to the intersected recommendation quadrants.

2. A computer-implemented method as defined in claim 1, wherein:
a. each of the plurality of risk questions relates to a risk factor of a plurality of risk factors;
b. each of the plurality of readiness questions relates to a readiness factor of a plurality of readiness factors;
c. each of the plurality of return questions relates to a return factor of a plurality of return factors;
d. determining the risk score includes determining a weighted average of a plurality of risk factor scores for each of the plurality of risk factors;
e. determining the readiness score includes determining a weighted average of a plurality of readiness factor scores for each of the plurality of readiness factors; and
f. determining the return score includes determining a weighted average of a plurality of return factor scores for each of the plurality of return factors.

3. A computer-implemented method as defined in claim 2, wherein:
a. determining the weighted average of the plurality of risk-factor scores is performed responsive to a user-selected risk-factor weighting profile;
b. determining the weighted average of the plurality of readiness-factor scores is performed responsive to a user-selected readiness-factor weighting profile; and
c. determining the weighted average of the plurality of return-factor scores is performed responsive to a user-selected return-factor weighting profile.

4. A computer-implemented method as defined in claim 2, the computer-implemented method further comprising determining each of a second risk score, a second readiness score, and a second return score for the business process responsive to the plurality of user-selected risk responses, the plurality of user-selected readiness responses, and the plurality of user-selected return responses, wherein:
a. determining the second risk score includes determining, responsive to a second user-selected risk-weighting profile, a second weighted average of the plurality of risk factor scores for each of the plurality of risk factors;
b. determining the second readiness score includes determining, responsive to a second user-selected readiness-weighting profile, a second weighted average of the plurality of readiness factor scores for each of the plurality of readiness factors;
c. determining the second return score includes determining, responsive to a second user-selected return-weighting profile, a second weighted average of the plurality of return factor scores for each of the plurality of return factors; and
d. displaying the outsourcing recommendation interface is further responsive to determining each of the second risk score, the second readiness score, and the second return score, the graphical chart further comprising:
i. a second process-recommendation bubble being displayed at a second position in the coordinate space responsive to each of the second risk score and the second readiness score and having a surface area responsive to the second return score, the second process bubble intersecting one or more of the four recommendation quadrants to provide a second graphical outsourcing recommendation for the business process to the user, when viewing the display, corresponding to the recommendation quadrants intersected by the second process bubble.

5. A computer-implemented method as defined in claim 2, wherein:
a. each of the plurality of risk questions relates to a risk parameter of a plurality of risk parameters, each of the plurality of risk parameters relating to a risk factor of the plurality of risk factors;
b. determining a risk-factor score for a respective risk factor includes averaging each of a plurality of risk-parameter scores for a respective risk parameter relating to the respective risk factor, each of the plurality of risk-parameter scores being determined by averaging each of the plurality of user-selected risk responses to a risk question relating to the respective risk parameter;
c. each of the plurality of readiness questions relates to a readiness parameter of a plurality of readiness parameters, each of the plurality of readiness parameters relating to a readiness factor of the plurality of readiness factors;
d. determining a readiness-factor score for a respective readiness factor includes averaging each of a plurality of readiness-parameter scores for a respective readiness parameter relating to the respective readiness factor, each of the plurality of readiness-parameter scores being determined by averaging each of the plurality of user-selected readiness responses to a readiness question relating to the respective readiness parameter;
e. each of the plurality of return questions relates to a return parameter of a plurality of return parameters, each of the plurality of return parameters relating to a return factor of the plurality of return factors; and
f. determining a return-factor score for a respective return factor includes averaging each of a plurality of return-parameter scores for a respective return parameter relating to the respective return factor, each of the plurality of return-parameter scores being determined by averaging each of the plurality of user-selected return responses to a return question relating to the respective return parameter.

6. A computer-implemented method as defined in claim 1, the computer-implemented method further comprising generating a second risk score, a second readiness score, and a second return score for a second business process responsive to a second plurality of user-selected risk responses relating to the second business process received at the plurality of risk response-fields, a second plurality of user-selected readiness responses relating to the second business process received at the plurality of readiness response-fields, and a second plurality of user-selected return responses relating to the second business process received at the plurality of return response-fields, wherein:
a. generating the outsourcing recommendation interface is further responsive to determining each of the second risk score, the second readiness score, and the second return score for the second business process; and
b. the graphical chart further comprises a second process-recommendation bubble for the second business process being displayed at a second position in the coordinate space responsive to each of the second risk score and the second readiness score and having a second surface area responsive to the second return score, the second process-recommendation bubble intersecting one or more of the four recommendation quadrants to provide a second graphical outsourcing recommendation for the second business process to a user, when viewing the display, corresponding to the intersected recommendation quadrants.

7. Non-transitory computer-readable storage medium to provide one or more graphical outsourcing recommendations for a business process to a user of a computing device having a display, the non-transitory computer-readable storage medium having stored thereon a set of executable instructions that when executed by a computer system cause the computer system to perform operations comprising:
a. generate an outsourcing questionnaire interface, to be displayed at a display of a computing device, the outsourcing questionnaire interface including a plurality of risk questions and a corresponding plurality of risk response-fields, a plurality of readiness questions and a corresponding plurality of readiness response-fields, and a plurality of return questions and a corresponding plurality of return response-fields;
b. determine a risk score for a business process responsive to a plurality of user-selected risk responses relating to the business process received at the plurality of risk response-fields;
c. determine a readiness score for the business process responsive to a plurality of user-selected readiness responses relating to the business process received at the plurality of readiness response-fields;
d. determine a return score for the business process responsive to a plurality of user-selected return responses relating to the business process received at the plurality of return response-fields; and
e. generate an outsourcing recommendation interface, to be displayed at a display of a computing device, the outsourcing recommendation interface recommending whether to outsource the business process responsive to each of the risk score and the readiness score and indicating the return score for the business process.

8. Non-transitory computer-readable storage medium as defined in claim 7, wherein:
a. the recommendation is expressed by a graphical chart including a process-recommendation bubble for the business process, the process-recommendation bubble being displayed at a position in the graphical chart responsive to each of the risk score and the readiness score and displayed of a size in the graphical chart responsive to the return score for the business process, and wherein:
i. the graphical chart, having a coordinate space defined by a first axis and a second axis, comprises four recommendation quadrants of the coordinate space, each of the four recommendation quadrants being indicative of a corresponding outsourcing recommendation; and
ii. the process-recommendation bubble for the business process intersects one or more of the four recommendation quadrants to provide a graphical outsourcing recommendation for the business process to a user, when viewing the display, corresponding to the intersected recommendation quadrants.

9. Non-transitory computer-readable storage medium as defined in claim 7, wherein:
a. each of the plurality of risk questions relates to a risk factor of a plurality of risk factors;
b. each of the plurality of readiness questions relates to a readiness factor of a plurality of readiness factors;
c. each of the plurality of return questions relates to a return factor of a plurality of return factors;
d. determining the risk score includes determining a weighted average of a plurality of risk factor scores for each of the plurality of risk factors;
e. determining the readiness score includes determining a weighted average of a plurality of readiness factor scores for each of the plurality of readiness factors; and
f. determining the return score includes determining a weighted average of a plurality of return factor scores for each of the plurality of return factors.

10. Non-transitory computer-readable storage medium as defined in claim 9, wherein:
a. determining the weighted average of the plurality of risk-factor scores is performed responsive to a user-selected risk-factor weighting profile;
b. determining the weighted average of the plurality of readiness-factor scores is performed responsive to a user-selected readiness-factor weighting profile; and
c. determining the weighted average of the plurality of return-factor scores is performed responsive to a user-selected return-factor weighting profile.

11. Non-transitory computer-readable storage medium as defined in claim 9, further comprising instructions to receive determine each of a second risk score, a second readiness score, and a second return score for the business process responsive to the plurality of user-selected risk responses, the plurality of user-selected readiness responses, and the plurality of user-selected return responses, wherein:
a. determining the second risk score includes determining, responsive to a second user-selected risk-weighting profile, a second weighted average of the plurality of risk factor scores for each of the plurality of risk factors;
b. determining the second readiness score includes determining, responsive to a second user-selected readiness-weighting profile, a second weighted average of the plurality of readiness factor scores for each of the plurality of readiness factors;
c. determining the second return score includes determining, responsive to a second user-selected return-weighting profile, a second weighted average of the plurality of return factor scores for each of the plurality of return factors; and
d. displaying the outsourcing recommendation interface is further responsive to determining each of the second risk score, the second readiness score, and the second return score, the graphical chart further comprising:
i. a second process-recommendation bubble being displayed at a second position in the coordinate space responsive to each of the second risk score and the second readiness score and having a surface area responsive to the second return score, the second process bubble intersecting one or more of the four recommendation quadrants to provide a second graphical outsourcing recommendation for the business process to the user, when viewing the display, corresponding to the recommendation quadrants intersected by the second process bubble.

12. Non-transitory computer-readable storage medium as defined in claim 9, wherein:
a. each of the plurality of risk questions relates to a risk parameter of a plurality of risk parameters, each of the plurality of risk parameters relating to a risk factor of the plurality of risk factors;
b. determining a risk-factor score for a respective risk factor includes averaging each of a plurality of risk-parameter scores for a respective risk parameter relating to the respective risk factor, each of the plurality of risk-parameter scores being determined by averaging each of the plurality of user-selected risk responses to a risk question relating to the respective risk parameter;
c. each of the plurality of readiness questions relates to a readiness parameter of a plurality of readiness parameters, each of the plurality of readiness parameters relating to a readiness factor of the plurality of readiness factors;
d. determining a readiness-factor score for a respective readiness factor includes averaging each of a plurality of readiness-parameter scores for a respective readiness parameter relating to the respective readiness factor, each of the plurality of readiness-parameter scores being determined by averaging each of the plurality of user-selected readiness responses to a readiness question relating to the respective readiness parameter;
e. each of the plurality of return questions relates to a return parameter of a plurality of return parameters, each of the plurality of return parameters relating to a return factor of the plurality of return factors; and
f. determining a return-factor score for a respective return factor includes averaging each of a plurality of return-parameter scores for a respective return parameter relating to the respective return factor, each of the plurality of return-parameter scores being determined by averaging each of the plurality of user-selected return responses to a return question relating to the respective return parameter.

13. Non-transitory computer-readable storage medium as defined in claim 8, further comprising instructions to generate a second risk score, a second readiness score, and a second return score for a second business process responsive to a second plurality of user-selected risk responses relating to the second business process received at the plurality of risk response-fields, a second plurality of user-selected readiness responses relating to the second business process received at the plurality of readiness response-fields, and a second plurality of user-selected return responses relating to the second business process received at the plurality of return response-fields, wherein:
a. generating the outsourcing recommendation interface is further responsive to determining each of the second risk score, the second readiness score, and the second return score for the second business process; and
b. the graphical chart further comprises a second process-recommendation bubble for the second business process being displayed at a second position in the coordinate space responsive to each of the second risk score and the second readiness score and having a second surface area responsive to the second return score, the second process-recommendation bubble intersecting one or more of the four recommendation quadrants to provide a second graphical outsourcing recommendation for the second business process to a user, when viewing the display, corresponding to the intersected recommendation quadrants.

14. A system to provide one or more graphical outsourcing recommendations for a business process to a user, the system comprising:
a. one or more processors;
b. a display communicatively coupled to the processor to display one or more user interfaces to a user when the display is viewed by the user;
c. a user input interface communicatively coupled with the processor to receive one or more selections by the user when the user input interface is accessed by the user;
d. non-transitory computer-readable storage medium to provide one or more graphical outsourcing recommendations for a business process to the user, the non-transitory computer-readable storage medium having stored thereon a set of executable instructions that when executed by a computer system cause the computer system to perform operations comprising:
i. generate an outsourcing questionnaire interface, to be displayed at a display of a computing device, the outsourcing questionnaire interface including a plurality of risk questions and a corresponding plurality of risk response-fields, a plurality of readiness questions and a corresponding plurality of readiness response-fields, and a plurality of return questions and a corresponding plurality of return response-fields,
ii. determine a risk score for a business process responsive to a plurality of user-selected risk responses relating to the business process received at the plurality of risk response-fields,
iii. determine a readiness score for the business process responsive to a plurality of user-selected readiness responses relating to the business process received at the plurality of readiness response-fields,
iv. determine a return score for the business process responsive to a plurality of user-selected return responses relating to the business process received at the plurality of return response-fields, and
v. generate an outsourcing recommendation interface, to be displayed at a display of a computing device, the outsourcing recommendation interface being a graphical chart including a process-recommendation bubble for the business process, the process-recommendation bubble being displayed at a position in the graphical chart responsive to each of the risk score and the readiness score and displayed of a size in the graphical chart responsive to the return score for the business process.

15. A system as defined in claim 14, wherein:
a. the graphical chart, having a coordinate space defined by a first axis and a second axis, comprises four recommendation quadrants of the coordinate space, each of the four recommendation quadrants being indicative of a corresponding outsourcing recommendation; and
b. the process-recommendation bubble for the business process intersects one or more of the four recommendation quadrants to provide a graphical outsourcing recommendation for the business process to a user, when viewing the display, corresponding to the intersected recommendation quadrants.

16. A system as defined in claim 14, wherein:
a. each of the plurality of risk questions relates to a risk factor of a plurality of risk factors;
b. each of the plurality of readiness questions relates to a readiness factor of a plurality of readiness factors;
c. each of the plurality of return questions relates to a return factor of a plurality of return factors;
d. determining the risk score includes determining a weighted average of a plurality of risk factor scores for each of the plurality of risk factors;
e. determining the readiness score includes determining a weighted average of a plurality of readiness factor scores for each of the plurality of readiness factors; and
f. determining the return score includes determining a weighted average of a plurality of return factor scores for each of the plurality of return factors.

17. A system as defined in claim 14, wherein:
a. determining the weighted average of the plurality of risk-factor scores is performed responsive to a user-selected risk-factor weighting profile;
b. determining the weighted average of the plurality of readiness-factor scores is performed responsive to a user-selected readiness-factor weighting profile; and
c. determining the weighted average of the plurality of return-factor scores is performed responsive to a user-selected return-factor weighting profile.

18. A system as defined in claim 14, the non-transitory computer-readable storage medium further comprising instructions to receive determine each of a second risk score, a second readiness score, and a second return score for the business process responsive to the plurality of user-selected risk responses, the plurality of user-selected readiness responses, and the plurality of user-selected return responses, wherein:
a. determining the second risk score includes determining, responsive to a second user-selected risk-weighting profile, a second weighted average of the plurality of risk factor scores for each of the plurality of risk factors;
b. determining the second readiness score includes determining, responsive to a second user-selected readiness-weighting profile, a second weighted average of the plurality of readiness factor scores for each of the plurality of readiness factors;
c. determining the second return score includes determining, responsive to a second user-selected return-weighting profile, a second weighted average of the plurality of return factor scores for each of the plurality of return factors; and
d. displaying the outsourcing recommendation interface is further responsive to determining each of the second risk score, the second readiness score, and the second return score, the graphical chart further comprising:
i. a second process-recommendation bubble being displayed at a second position in the coordinate space responsive to each of the second risk score and the second readiness score and having a surface area responsive to the second return score, the second process bubble intersecting one or more of the four recommendation quadrants to provide a second graphical outsourcing recommendation for the business process to the user, when viewing the display, corresponding to the recommendation quadrants intersected by the second process bubble.

19. A system as defined in claim 14, wherein:
a. each of the plurality of risk questions relates to a risk parameter of a plurality of risk parameters, each of the plurality of risk parameters relating to a risk factor of the plurality of risk factors;
b. determining a risk-factor score for a respective risk factor includes averaging each of a plurality of risk-parameter scores for a respective risk parameter relating to the respective risk factor, each of the plurality of risk-parameter scores being determined by averaging each of the plurality of user-selected risk responses to a risk question relating to the respective risk parameter;
c. each of the plurality of readiness questions relates to a readiness parameter of a plurality of readiness parameters, each of the plurality of readiness parameters relating to a readiness factor of the plurality of readiness factors;
d. determining a readiness-factor score for a respective readiness factor includes averaging each of a plurality of readiness-parameter scores for a respective readiness parameter relating to the respective readiness factor, each of the plurality of readiness-parameter scores being determined by averaging each of the plurality of user-selected readiness responses to a readiness question relating to the respective readiness parameter;
e. each of the plurality of return questions relates to a return parameter of a plurality of return parameters, each of the plurality of return parameters relating to a return factor of the plurality of return factors; and
f. determining a return-factor score for a respective return factor includes averaging each of a plurality of return-parameter scores for a respective return parameter relating to the respective return factor, each of the plurality of return-parameter scores being determined by averaging each of the plurality of user-selected return responses to a return question relating to the respective return parameter.

20. A system as defined in claim 14, the non-transitory computer-readable storage medium further comprising instructions to generate a second risk score, a second readiness score, and a second return score for a second business process responsive to a second plurality of user-selected risk responses relating to the second business process received at the plurality of risk response-fields, a second plurality of user-selected readiness responses relating to the second business process received at the plurality of readiness response-fields, and a second plurality of user-selected return responses relating to the second business process received at the plurality of return response-fields, wherein:
a. generating the outsourcing recommendation interface is further responsive to determining each of the second risk score, the second readiness score, and the second return score for the second business process; and
b. the graphical chart further comprises a second process-recommendation bubble for the second business process being displayed at a second position in the coordinate space responsive to each of the second risk score and the second readiness score and having a second surface area responsive to the second return score, the second process-recommendation bubble intersecting one or more of the four recommendation quadrants to provide a second graphical outsourcing recommendation for the second business process to a user, when viewing the display, corresponding to the intersected recommendation quadrants.
